(19) United States
(12) Patent Application Publication
(10) Pub. No.: US 2024/0387821 A1
(43) Pub. Date: Nov. 21, 2024

(54) Lithium Sulfur Cell

(71) Applicant: Cambridge Enterprise Limited, Cambridge, Cambridgeshire (GB)

(72) Inventors: Manish Chhowalla, Cambridge (GB); Zhuangnan Li, Cambridge (GB)

(21) Appl. No.: 18/690,688

(22) PCT Filed: Sep. 20, 2022
(86) PCT No.: PCT/EP2022/076077

§ 371 Date: Mar. 8, 2024

(30) Foreign Application Priority Data
Sep. 20, 2021 (GB) 2113364.0

(51) Int. Cl. H01M 4/58; H01M 4/02; H01M 4/36; H01M 10/052; H01M 10/44

(52) U.S. Cl. CPC H01M 4/5815; H01M 4/366; H01M 10/052; H01M 10/44; H01M 2004/028

(57) ABSTRACT

The invention relates to a lithium sulfur cell, a method of preparing a lithium sulfur cell, and a battery comprising the lithium sulfur cell. The lithium sulfur cell comprises a working electrode comprising a film comprising stacked layers of a metallic phase transition metal dichalcogenide of formula (I): LiₐMX₂ where a is from 0.0 to 2.0, X is selected from S, Se and Te, and M is a transition metal, such as Ti, Hf, V, Nb, Ta, Mo, W, Tc, Re, Pd or Pt. The method of preparing a lithium sulfur cell comprises: exfoliating a transition metal dichalcogenide to provide a metallic phase. transition metal dichalcogenide of formula (I); assembling a working electrode comprising a film comprising stacked layers of the metallic phase transition metal dichalcogenide and sulfur or a lithium (poly) sulfide: and assembling a lithium sulfur cell comprising the working electrode, a counter electrode, and an electrolyte.

### RELATED APPLICATION

The present case claims priority to, and the benefit of, GB 2113364.0 filed on 20 Sep. 2021 (20.09.2021), the contents of which are hereby incorporated by reference in their entirety.

### FIELD OF THE INVENTION

The invention relates to a lithium sulfur cell, a method of preparing a lithium sulfur cell, and a battery comprising the lithium sulfur cell.

### BACKGROUND

The transition to net zero carbon emission will require a step change in performance of electronic devices. Batteries based on new chemistries that overcome the fundamental limitations of lithium ion batteries will play an important role in enabling a transition to higher performance electronic devices.

Lithium sulfur (Li—S) batteries have the potential to offer high energy density, low material cost and excellent safety. Li—S batteries are based on conversion reactions between S₆ and Li₂S, which can overcome the limitations of insertion oxide cathodes and graphite anodes used in traditional lithium-ion batteries. However, fundamental challenges such as low sulfur utilization in the cathode, slow reaction rate, self-discharge, poor capacity retention and short lifetimes have hampered Li—S batteries development.

Known Li—S batteries use a sulfur cathode and a lithium metal anode. The electrically insulating nature of sulfur means that it must be loaded onto a more conductive host, typically carbon, modified carbonaceous materials or functional polymeric materials. Binders are often required, to bind the sulfur-carbon cathode. However, the high ratio of carbon and binder “scaffold” relative to sulfur leads to a decrease in overall energy density. This is due to the presence of additional inactive components in the cathode, and a higher electrolyte to sulfur ratio.

The carbon is also often hydrophobic and therefore is poorly wetted by the electrolyte. This hinders ion diffusion between the electrolyte and cathode, lowering both capacity and rate capability.

In addition, weak interactions between sulfur and carbon can result in loss of sulfur by dissolution into the electrolyte. The lithium polysulfides (LiPS) having the formula Li₂Sₓ, where 2≤x≤8, are readily solubilised by electrolyte and diffuse towards the anode. This effect is particularly pronounced for Li₂S₆ and Li₂S₈. This “polysulfide shuttling” effect results in self-discharge, poor capacity retention and short battery lifetimes.

Typically, Li—S cathodes may also include non-conducting electrocatalysts dispersed on the conductive framework. This introduces internal solid-solid interfacial charge transfer resistance, reducing the number of electrons reaching the active sides.

Another issue of traditional sulfur cathodes is the volume expansion during discharge. Conversion between S₈ and Li₂S can result in a volume expansion of nearly 80%. The mechanical stress of the expansion may cause the electrode to fracture, thereby lesioning sections of the electrode, reducing cathode conductivity and battery capacity.

Accordingly, there is a need for a Li—S battery having improved energy density, reaction rate, resistance to self-discharge, capacity retention and lifetime.

### SUMMARY OF THE INVENTION

At its most general, the invention provides a lithium sulfur cell (Li—S) having a working electrode comprising a metallic phase transition metal dichalcogenide of formula (I):

LiₐMX₂ (I)

where a is from 0.0 to 2.0, X is selected from S, Se and Te, and M is a transition metal.

Accordingly, in a first aspect of the invention there is provided a lithium sulfur cell comprising a working electrode, a counter electrode, and an electrolyte, wherein the working electrode comprises a film comprising:

stacked layers of a metallic phase transition metal dichalcogenide of formula (I); and sulfur or a lithium (poly) sulfide,

LiₐMX₂ (I)

where:
a is from 0 to 2.0;
X is selected from S, Se and Te; and
M is a transition metal.

The inventors have found that the Li—S battery of the first aspect has excellent electrochemical properties. The metallic phase transition meal dichalcogenide electrode material works simultaneously as a conductive substrate and an electrocatalyst. Thus, in contrast to typical Li—S electrodes comprising non-conducting electrocatalysts dispersed on a conductive framework, the electrode material used in the battery of the first aspect is a single material with no solid-solid interface. This facilitates electron transport to electrocatalytic active sites to and thus allows the sulfur reduction reaction (SRR) to proceed efficiently.

Additionally, the Li—S battery of the first aspect also has advantageously high gravimetric and volumetric energy density. The metallic phase transition metal dichalcogenide electrode does not require binders to secure the sulfur in the electrode. Without wishing to be bound by theory, the sulfur is securely deposited between nanosheets of the layered transition metal dichalcogenide, and the high affinity for this site removes the need for a binder. Also, the freestanding nature and good conductivity of the metallic phase transition metal dichalcogenide electrodes of the invention mean the cathode can be used without a current collector. This also increases the energy density of the battery.

Moreover, the Li—S battery of the first aspect is less susceptible to fracturing of the electrode material, compared to known sulfur cathodes. The volumetric expansion between S& and Li₂S is absorbed by the layered material. Thus, the electrode is less susceptible to cracking and lesioning of electrode material. This means the battery is more stable, has improved capacity retention and a longer cycling lifetime.

Preferably, a lithiated, metallic phase transition metal dichalcogenide is used. Accordingly, in a second aspect of the invention there is provided a lithium sulfur cell comprising a working electrode, a counter electrode, and an electrolyte, wherein the working electrode comprises a film comprising:
stacked layers of a lithiated, metallic phase transition metal dichalcogenide of formula (I); and
sulfur or a lithium (poly) sulfide,

LiₐMX₂ (I)
where:
   a is from 0.1 to 2.0;
   X is selected from S, Se and Te; and
   M is a transition metal.

Preferably, a metallic phase niobium or molybdenum disulfide is used. Accordingly, in another aspect of the invention there is provided a lithium sulfur cell comprising a working electrode, a counter electrode, and an electrolyte, wherein the working electrode comprises a film comprising:
stacked layers of a metallic phase transition metal dichalcogenide of formula (I); and sulfur or a lithium (poly) sulfide,

LiₐMX₂ (I)
where:
   a is from 0 to 2.0;
   X is S; and
   M is a Nb or Mo.

In some such embodiments, a is from 0.1 to 2.0. Preferably, the stacked layers of a metallic phase transition metal dichalcogenide are pre-lithiated. Preferably, the working electrode comprises conductive carbon in an amount of 5 wt. % or less, such as 1 wt % or less.

The inventors have surprisingly found that the Li—S battery of the second aspect has further improved electrochemical properties and improved sulfur utilization. The Li—S batteries demonstrated in the examples have a sulfur utilization of greater than 85%. As a result, the Li—S battery of the invention has an advantageously high areal capacity and excellent capacity retention following repeated cycling.

Without wishing to be bound by theory, it is though this is due to improved adsorption of lithium polysulfides, enhanced Li⁺ ion diffusivity, accelerated electrochemical reaction kinetics and superior electrocatalytic activity for polysulfide conversion provided by the working electrode material.

The lithiated, metallic phase transition meal dichalcogenide electrode material displays improved electrocatalytic activity. Without wishing to be bound by theory, it is thought that lithium intercalated between the layers of metallic phase transition metal dichalcogenide facilitates the diffusion of Li ions through the material, resulting in enhanced Li ion diffusivity.

The lithiated, metallic phase transition meal dichalcogenide electrode material retains the excellent conductive properties of the non-lithiated material and avoiding the need to use additional conductive components or binders in the electrode. The freestanding nature means the electrode can be used without a current collector. Moreover, the high concentration of sulfur which can be deposited in the electrode material further reduces the ratio of “scaffold” to sulfur. Thus, the excellent gravimetric and volumetric energy density are obtained.

In addition, the working electrode used in the Li—S battery of the second aspect has improved electrolyte wetting of the electrode surface. Without wishing to be bound by theory, it is thought that the more lyophilic property of the electrode material can be attributed to its polar nature (e.g. compared to relatively non-polar carbon which is hydrophobic). This lyophilicity is thought to be beneficial in yielding lower electrode-electrolyte interfacial resistance for the electrode, as there is improved ion diffusion between the electrode-electrolyte. This results in an advantageously high rate capabilities and fast reaction rates for the Li—S battery.

A further advantage of the improved electrolyte wetting is that a smaller volume of electrolyte can be used in the battery. This reduces the mass of the battery, thus improving energy density. In addition, the smaller volume of electrolyte reduces the propensity for the electrolyte to solubilise Li₂Sₓ components, which in turn reduces “polysulfide shuttling”.

On this point, the working electrode used in the Li—S batteries of the second aspect also exhibits excellent retention of sulfur and Li₂Sₓ components. In particular, the highly electrolyte soluble Li₂Sₓ components (where 2≤x≤8, and in particular Li₂S₆ and Li₂S₈) have a high affinity for the metallic phase transition metal dichalcogenide. Without wishing to be bound by theory, it is thought that there are sulfur vacancies in the layered transition metal dichalcogenide that may act as binding sites for sulfur immobilization. It is thought this reduces the propensity for dissolution of the Li₂Sₓ component into the electrolyte, which in turn reduces “polysulfide shuttling” as the Li₂Sₓ components are transported through the electrolyte and irreversibly deposited on the anode. This means the undesirable self-discharge and poor capacity retention properties of known Li—S batteries are mitigated. It also results in improved battery lifetimes compared to known Li—S batteries.

Furthermore, Li⁺ ions possess strong binding with the transition metal dichalcogenide, which is beneficial in minimizing the dissolution of LiPS in electrolyte.

The lithiated, metallic phase transition metal dichalcogenide retains the layered structure of the non-lithiated material. Thus, the Li—S batteries of the second aspect are less susceptible to fracturing of the electrode material in comparison to known sulfur cathodes as the volumetric expansion between S₈ and Li₂S is absorbed by the layered material. This means the battery is more stable, has improved capacity retention and a longer cycling lifetime.

These advantages make the invention uniquely suitable for boosting the performance of Li—S batteries, and provide a Li—S battery with real world feasibility.

In a third aspect of the invention, there is provided a method of preparing a lithium sulfur cell, the method comprising:
(a) exfoliating a transition metal dichalcogenide to provide a metallic phase, transition metal dichalcogenide of formula (I):

LiₐMX₂ (I)
where:
   a is from 0 to 2.0;
   X is selected from S, Se and Te; and
   M is a transition metal,
(b) assembling a working electrode comprising a film comprising stacked layers of the metallic phase transition metal dichalcogenide and sulfur or a lithium (poly) sulfide; and
(c) assembling a lithium sulfur cell comprising the working electrode, a counter electrode, and an electrolyte.

In a fourth aspect of the invention, there is provided a lithium sulfur cell obtained or obtainable by the method of the third aspect.

The use of a lithiated layered transition metal dichalcogenide in the working electrode provides a lithium sulfur cell having improved sulfur utilization. The working electrode displays increased electrolyte wetting, improved adsorption of lithium polysulfides, excellent retention of sulfur, enhanced Li-ion diffusivity, accelerated electrochemical reaction kinetics and superior electrocatalytic activity for polysulfide conversion. The layered electrode material withstands volumetric expansion and so is less susceptible to fracturing. As a result, the Li—S battery has an advantageously high areal capacity and excellent capacity retention following repeated cycling.

In a fifth aspect of the invention, there is provided a lithium sulfur battery comprising one or more lithium sulfur cells of the first, second or fourth aspects.

In a sixth aspect of the invention, there is provided a method of charging and/or discharging the lithium sulfur cell of the first, second or fourth aspects.

In a seventh aspect of the invention, there is provided the use of a metallic phase transition metal dichalcogenide of formula (I) as a conductive substrate in a working electrode of a lithium sulfur cell,

LiₐMX₂ (I)
where:
   a is from 0 to 2.0;
   X is S, Se or Te; and
   M is a transition metal.

Using the lithiated, metallic phase transition metal dichalcogenide of formula (I) as a conductive substrate in a working electrode of a lithium sulfur cell avoids the need to use conductive carbon. This improves the gravimetric and volumetric energy density of the Li—S of the invention. In addition, the use of a single material means there are fewer solid-solid interfaces within the electrode, facilitating electron transport to electrocatalytic active sites and allowing the SRR to proceed efficiently.

These and other aspects and embodiments of the invention are described in further detail below.

### SUMMARY OF THE FIGURES

The invention is described with reference to the figures listed below.

FIG. 1a shows photographs of a freestanding LiₓMoS₂ film. FIG. 1b shows a cross-sectional scanning electron microscopy image of the LiₓMoS₂ film showing laminar structure of stacked nanosheets. Scale bar, 1 μm. FIGS. 1c and 1d, show X-ray diffraction patterns (c) and Raman spectra (d) of LiₓMoS₂ (top) in comparison with pristine 2H MOS₂ powder (bottom). FIG. 1e shows a high resolution XPS spectra of Mo 3d, showing ˜85% concentration of the metallic 1T phase (peaks at approx. 232 eV and 228 eV) compared to the 2H phase (peaks at approx. 233 and 229 eV) in LiₓMoS₂.

FIG. 2a shows galvanostatic charge-discharge curves at a current density of 0.1 C exhibiting typical discharge plateaus at 2.4 V (Li₂S₆ to Li₂S₄) and 2.1 V (Li₂S₄ to Li₂S₂/Li₂S). 2H MOS₂ (left), 2H MoS₂/C (centre left), 1T MoS₂ (centre right) and LiₓMoS₂ (right). FIG. 2b shows specific capacities at different current densities, showing the rate capability of different cathodes 2H MOS₂ (bottom), 2H MoS₂/C (one from bottom), 1T MoS₂ (one from top) and LiₓMoS₂ (top) when cycled at 0.1C, 0.20, 0.5C, 1C and 2C. FIG. 2c shows volumetric capacity and sulfur loading comparison of LiₓMoS₂ cathode with reference cathodes. The dashed lines represent three different gravimetric capacities as labelled. FIG. 2d shows the cycling stability of different cathodes at a current density of 1 C, showing ˜91% capacity retention of LiₓMoS₂ cathodes over 500 cycles, compared to 2H MOS₂ (bottom), 2H MoS₂/C (one from bottom), 1T MoS₂ (one from top).

FIG. 3a shows a photograph and UV-vis spectra of the Li₂S₄ solutions after exposure to different MoS₂ hosts for LiPS adsorption study. Li₂S₄ (top line; left photo), 2H MoS₂ (top middle line; centre left photo), 2H MoS₂/C (centre line; centre photo), 1T MoS₂ (bottom middle line; centre right photo) and LiₓMoS₂ (bottom line; right photo). The photograph shows that the supernatant liquid with LiₓMoS₂ is transparent, suggesting excellent adsorption of the LiPS. The UV-vis spectra, shows that the Li₂S₄ solution exposed to LiₓMoS₂ host has the lowest absorbance, suggesting excellent adsorption of the LiPS. FIGS. 3b and 3c show cyclic voltammetry curves of LiₓMoS₂ cathode at various scan rates showing two cathodic and one anodic peak (b) and the corresponding Randles-Sevcik plot of peak current versus square root of scan rate (c) used to derive DLi values. FIG. 3d shows Nyquist plots at 2.1 V at room temperature and the equivalent circuit (inset) used for fitting electrochemical impedance spectroscopy profiles. FIG. 3e shows an Arrhenius plots of LiₓMoS₂ cathode at various voltages, where the reciprocal of charge transfer resistance is used to describe the rate of polysulfide conversion reaction. FIG. 3f shows activation energy of different MoS₂ cathodes (2H MOS₂ (top), 2H Mo_{S}2/C (one from top), 1T MoS₂ (one from bottom) and LiₓMoS₂ (bottom) at various voltages, revealing the reaction kinetics by energy required for each polysulfide conversion step. Peaks are present at 2.4 V and 2.1 V.

FIGS. 4a and 4b show linear sweep voltammetry (LSV) curves towards Li₂S₄ conversion at a sweep rate of 20 mV s⁻¹ (a) and their corresponding Tafel plots (b). Line ordering in

FIG. 4a at left, 2H MOS₂ (top), 2H MoS₂/C (top middle), 1T MoS₂ (bottom middle) and LiₓMoS₂ (bottom). FIG. 4c shows the LSV curves of LiₓMoS₂ host at a sweep rate of 20 mV s⁻¹ at rotating rates of 400 rpm (top at left), 625 rpm (top middle at left), 900 rpm (bottom middle at left) and 1600 rpm (bottom at left). FIG. 4d shows electron transfer number for different MoS₂ hosts during Li₂S₄ conversion process, derived from LSV curves of different rotating rates according to Koutecky-Levich equation.

FIG. 5a shows specific capacity retention with varying areal capacities by increasing the areal sulfur loading of LiₓMoS₂ cathodes. The optimal loading was found to be 7.5 mg cm⁻². FIG. 5b shows a comparison of areal capacities at different current densities with reported Li—S batteries (triangular symbols) and LIBs (square symbols) fabricated using different types of materials. FIG. 5c shows a gravimetric and volumetric energy densities comparison of LiₓMoS₂-based Ah-level pouch cells with reference Li—S batteries (triangular symbols) of Mo₆S₈/C, metal-organic framework/carbon nanotubes (MOF/CNT), multi-walled carbon nanotubes (MWCNT) and graphitic carbon nitride/graphene (g-C₃N₄/G) cathodes; reference Li—S batteries (triangular symbols) from Oxis Energy and Sion Power; reference LIBs (square symbols) of LifePO₄ (LFP), LiNi_{0.8}Co_{0.1}Mn_{0.1}O₂ (NCM 811), LiNi_{0.6}Co_{0.2}Mn_{0.2}O₂ (NCM 622), and LiNi_{0.8}Co_{0.5}Al_{0.05}O₂ (NCA) cathodes from BYD, CATL, LG and Panasonic companies, respectively; and other reference energy storage technologies (ellipses with shadow). All presented energy density values are calculated on the basis of the entire device configuration, rather than the electrode material only. FIG. 5d shows a photograph of a fabricated LiₓMoS₂-based Li—S pouch cell (inset) and its cycling stability at a current density of 2 mA cm⁻².

FIG. 6a shows a high-resolution XPS spectra of Li 1 s of LiₓMoS₂. FIG. 6b shows an electrochemical lithium extraction measurement in the cell of bare LiₓMoS₂ film versus lithium foil. The lithium content in the LiₓMoS₂ sample is ˜0.7 (per transition metal).

FIG. 7 shows the thermogravimetric analyses of the LiₓMoS₂ cathode. The sulfur content of the sample is 71.6 wt. %.

FIG. 8 shows a cross-sectional SEM image of the LiₓMoS₂ cathode. Scale bar, 5 μm.

FIG. 9 shows an electrolyte wetting of (a) LiₓMoS₂ and (b) 2H MOS₂. The LiₓMoS₂ is more lyophilic than the 2H MOS₂.

FIG. 10 shows a schematic diagram illustrating the configuration of LiₓMoS₂-based pouch cells. FIG. 10a shows a schematic of each component of the Li—S pouch cell with the corresponding thickness. FIG. 10b shows a configuration of the Ah-level pouch cell core with layer-by-layer stacked LiₓMoS₂ cathodes and the lithium foil anodes (6 layers of each electrode). FIG. 10c shows the configuration of the cell core for delivering a total capacity of >2 Ah. FIG. 10d shows gravimetric and volumetric energy densities comparison between the actual and projected Ah-level pouch cells showing an enhancement of ˜30% on both energy densities after optimization (Eg=520 Wh kg⁻¹ and Evol=940 Wh l⁻¹).

FIG. 11 shows an X-ray diffraction pattern for metallic phase 3R-NbS₂ prepared by a chemical vapour transport method.

FIG. 12 shows galvanostatic charge-discharge curves at a current density of 0.1 C exhibiting typical discharge plateaus at 2.4 V (Li₂S₆ to Li₂S₄) and 2.1 V (Li₂S₄ to Li₂S₂/Li₂S). The curves shown are for 1T MoS₂ (dotted line, left line at top right), 3R NbS₂ (dashed line, centre line at top right) and LiₓMoS₂ (solid line, right line at top right).

### DETAILED DESCRIPTION OF THE INVENTION

At its most general, the invention provides a lithium sulfur (Li—S) cell having a working electrode comprising a metallic phase transition metal dichalcogenide:

LiₐMX₂ (I)
where a is from 0 to 2.0, X is selected from S, Se and Te, and M is a transition metal.

Transition metal dichalcogenides (TMDs) are compounds of a transition metal (for example, Ti, Hf, V, Nb, Ta, Mo, W, Tc, Re, Pd or Pt) with a chalcogen (sulfur, selenium or tellurium). TMDs typically have the formula MX₂, where M is the transition metal and X is the chalcogen. In these materials, the transition metal is sandwiched between layers of the chalcogen to form an X-M-X stack or sheet. Thus, TMDs are examples of “layered materials”. Layered materials are highly anisotropic, and exist bulk form as stacks of 2-dimensional (2D) in sheets which may together form a 3-dimensional (3D) crystal. The bonding in-plane (i.e. within the layer or sheet) typically comprises strong chemical bonds, whereas the layers themselves are held together by weaker forces, such as van der Waals forces, which permits exfoliation to form individual nanosheets or monolayers.

CN 111293293 describes a molybdenum disulfide, carbon nanotube-sulfur composite cathode for a Li—S cell. The MoS₂ is in a semiconducting 2H phase, not a metallic phase, and includes carbon nanotubes to assist with conductivity. CN 111293293 does not describe lithiated TMDs or exfoliated TMDs.

KR 1020200025409 describes a carbon nanostructure-MoS₂ composite as a cathode for Li—S cells. The MoS₂ is coated on a carbon nanostructure. The MosS₂ is in a semiconducting 2H phase, not a metallic phase. The electrode includes a carbon nanostructure to provide conductivity for the semi-conducting MoS₂. The cathode is prepared by annealing MoS₂ at 600° C. At this temperature any metallic phase MoS₂ will transform to semiconducting 2H phase MoS₂. KR 1020200025409 does not describe stacked layers of MoS₂, and does not mention lithiated or exfoliated TMDs.

CN 108232164 describes lithium polysulfide hosts such as Mo, W, Cr, Fe, Co or Ni sulfides supported on carbon nanotubes. The transition metal sulfides are in a semiconducting phase, not a metallic phase. The transition metal sulfides are provided on a carbon nanotube support, to assist with conductivity. CN 108232164 does not describe stacked layers of TMDs or lithiated TMDs.

CN 108649194 relates to a reduced graphene oxide supported MoS₂ cathode for a Li—S battery. The material is described as a “nanosheet aerogel”. The MoS₂ is reported to be dispersed in the middle of graphene oxide lamellae. The MoS₂ material is in a semiconducting phase and the graphene oxide assists with electrical conductivity of the MoS₂. CN 108649194 does not describe metallic phase TMDs, and does not mention lithiated or exfoliated TMDs.

WO 2018/226158 describes MoS₂ around a sulfur particle for Li—S cathodes. MoS₂ is treated with an organo-lithium, and is layered onto a sulfur particle. The MoS₂ is in a semiconducting 2H phase when formed into an electrode for a Li—S cell. Metallic MoS₂ is not formed during the exfoliation described in WO 2018/226158. The organo-lithium is at too low a mole ratio compared to the MoS₂ and the treatment is for too short a time to form the metallic phase MoS₂. The electrode described in WO 2018/226158 includes a high proportion of conductive carbon fibre, as evidenced by the relatively low active material loading of 1.5 mg/cm². The carbon fibre is required to provide conductivity for the semiconducting MoS₂ phase.

US 2019/0165365 relates to anode materials for lithium or sodium ion batteries, including intercalation compounds for lithium ions. Li—S cells are not described. Intercalation compounds for suflur or lithium polysulfides are not described.

### Working Electrode

The Li—S cell of the invention comprises a working electrode. The working electrode may be a positive (cathode) or negative (anode) electrode, for example during a discharge step. Typically, the working electrode is the positive electrode (cathode).

The working electrode comprises a (lithiated) transition metal dichalcogenide of formula (I):

LiₐMX₂ (I)

The group M in formula (I) is the transition metal. The transition metal M may be selected from Ti, Hf, Zr, V, Nb, Ta, Mo, W, Tc, Re, Pd and Pt.

Preferably, the transition metal M is selected from V, Nb, Ta, Mo and W. More preferably, the transition metal M is selected from V, Nb, Mo and W. Even more preferably, the transition metal is selected from Nb or Mo. Most preferably, the transition metal M is Mo.

The worked examples demonstrate that a Li—S cell in which the working electrode comprises lithiated molybdenum disulfide (LiₓMoS₂) has excellent sulfur utilization, excellent capacity retention and long cycling lifetime. The inventors expect additional lithiated transition metal dichalcogenide to perform well in an Li—S cell based on similar the electrochemical properties that have demonstrated in related systems such as electrocatalytic hydrogen evolution, lithium ion batteries and supercapacitors (Chhowalla et al, 2013).

The transition metal dichalcogenide is in the metallic phase.

The metallic phase is a phase having its Fermi level (E₁) within an electron orbital band. This may occur when the highest energy occupied electron orbital is partially filled. This contrasts with a semiconducting phase, where the E_{f} is in an energy gap between two orbital bands.

This may occur when the highest energy occupied electron orbital is fully filled, and there is an energy gap between the highest energy occupied orbital and lowest energy unoccupied orbital. Metallic phase materials are conductors at absolute zero (0 K), whereas semiconductors are insulators at absolute zero.

In the metallic phase, Li⁺ ions possess strong binding with the metallic phases of transition metal dichalcogenides such as MoS₂, which is beneficial in minimizing the dissolution of LiPS in electrolyte.

The metallic phase is also highly conducting, mitigating the need to use additional conductive additives, such as conductive carbon, in the working electrode.

The transition metal dichalcogenide may have any structure (polymorph) having a metallic phase. Transition metal dichalcogenide may be in the metallic phase in the 1T, 2H or 3R polymorph. Here, the letters stand for trigonal, hexagonal and rhombohedral, respectively, while the number indicates the number of X-M-X units in the unit cell. For example, the 1T polymorphs of MoS₂ and WS₂ are metallic, while both the 2H and 3R polymorphs of NbS₂ are metallic.

In a particularly preferred embodiment, the transition metal dichalcogenide is in the metallic 1T phase. Li⁺ ions possess strong binding with the 1T phase of MoS₂, which is beneficial in minimizing the dissolution of LiPS in electrolyte (Bediako et al, 2018).

In an additional preferred embodiment, the transition metal dichalcogenide is in the metallic 3R phase. For example, the transition metal dichalcogenide may be a NbS₂ in the metallic 3R phase.

The working electrode may comprise lithiated transition metal dichalcogenide in additional phases. Preferably, the proportion of lithiated transition metal dichalcogenide in the metallic phase is from 60% to 100%. More preferably, the proportion of lithiated transition metal dichalcogenide in the metallic phase is from 70% to 95%, even more preferably from 80% to 90%.

The working electrode may comprise lithiated transition metal dichalcogenide in additional phases. Preferably, the proportion of lithiated transition metal dichalcogenide in the 1T phase is from 60% to 100%. More preferably, the proportion of lithiated transition metal dichalcogenide in the 1T is phase is from 70% to 95%, even more preferably from 80% to 90%.

The phase of the transition metal dichalcogenide may be known or it may be determined using standard techniques, such as X-ray photoelectron spectroscopy (XPS).

The working electrode of the invention comprises stacked layers of the transition metal dichalcogenide.

Accordingly, the transition metal dichalcogenide is preferably a layered material. In the layered material, the transition metal is sandwiched between layers of the chalcogen to form an X-M-X stack or sheet. In layered materials, the bonding in-plane (i.e. within the layer or sheet) typically comprises strong chemical bonds, whereas the layers themselves are held together by weaker forces, such as van der Waals forces.

Preferably, the transition metal dichalcogenide is a two-dimensional (2D) material. Thus, the working electrode comprises nanosheets or monolayers of the transition metal dichalcogenide.

Individual nanosheets can have a (geometric) surface area of the order of μm², but typically have a thickness of about a nanometre. In some embodiments the thickness of a nanosheet is about 0.7 nm.

Individual nanosheets or flakes of the transition metal dichalcogenide may be restacked to form a film. Thus, the transition metal dichalcogenide preferably comprises restacked transition metal dichalcogenide, such as restacked flakes of exfoliated, transition metal dichalcogenide.

The restacked film of nanosheets may have a surface area of the order of mm², and typically have a thickness of from 1 to 100 μm. Typically, the restacked film comprises 10 or more layers, preferably 20 or more layers, more preferably 50 or more layers, even more preferably 100 or more layers.

The 2D transition metal disulfide may be prepared by exfoliation. Thus, the transition metal dichalcogenide is preferably an exfoliated transition metal dichalcogenide, such as exfoliated flakes, nanosheets or monolayers of the transition metal dichalcogenide.

The working electrode comprises a film comprising stacked layers of the transition metal dichalcogenide. Thus, the film has a layered (or laminar) structure. The layered working electrode has improved cycle stability in comparison to the bulk metallic TMD crystals as it able to withstand volumetric expansion, such as that arising from the conversion between S₈ and Li₂S, and so is less susceptible to fracturing.

The orientation of each layer (e.g. each nanosheet, monolayer or flake) is typically parallel to the orientation of the film. (That is, the normal vector of each individual layer is aligned with the normal vector of the film to within a few degrees, such as within 10° or 5°).

As discussed in more detail below, the film may be prepared by restacking exfoliated, metallic phase, transition metal dichalcogenide, such as individual transition metal disulfide nanosheets, monolayers or flakes.

The thickness of the film may depend on the sulfur loading (see below). Typically, the film has a thickness of from 1 to 100 μm. Preferably, the film has a thickness of from 2 to 10 μm, more preferably 2 to 5 μm, even more preferably 2 to 3 μm.

The value a in formula (I) may be referred to as the lithiation rate. The lithiation rate a is 0 or more. The upper limit for the lithiation rate is not particularly limited. Typically, the upper limit for the lithiation rate is around 2.0.

In some embodiments, the lithiation rate is 0.05 or less, such as 0. In such cases, the metallic phase transition metal dichalcogenide is unlithiated, such as when the cell is constructed.

Preferably, the transition metal dichalcogenide is lithiated (comprises lithium). Lithiation of the transition metal dichalcogenide enhances the Li⁺ ion diffusion kinetics within the electrode material.

As discussed in more detail below, the lithiated transition metal dichalcogenide can retain the layered structure of the material. Thus, the lithiated transition metal dichalcogenide is a two-dimensional (2D) material, and the working electrode comprises nanosheets or monolayers of the lithiated transition metal dichalcogenide. Typically, the lithiated material exists as individual stacks or sheets of transition metal disulfide (X-M-X) containing lithium ions (Li⁺) in between the sheets.

The lithiated transition metal dichalcogenide typically includes lithium ions which are not from a lithium (poly) sulfide. In such cases, the lithiation is distinct from the inclusion of lithium poly (sulfide) in the working electrode. In other words, the lithium ions are not from the lithium poly (sulfide).

Accordingly, the lithiation rate a is typically from 0.1 to 2.0. Preferably, the lithiation rate is from 0.1 to 1.5, more preferably 0.3 to 1.2, even more preferably 0.5 to 0.9, and most preferably from 0.6 to 0.8. In the worked examples, the lithiation rate is about 0.7.Preferably, the lithiation occurs prior to formation of the Li—S cell. Thus, the working electrode may be described as a “pre-lithiated” electrode. In such cases, the working electrode comprises stacked layers of the pre-lithiated, metallic phase transition metal dichalcogenide of formula (I). In such cases, the lithiation occurs before sulfur or lithium (poly) sulfide is added to the working electrode (e.g. before operation of the Li—S cell). In other words, the lithium ions are not from the lithium poly (sulfide). The lithium poly (sulfide) may only be introduced during the first cycle of the Li—S cell.

The lithiated transition metal dichalcogenide may be prepared by chemical or electrochemical lithiation. Preferably, the lithiated transition metal disulfide is prepared by chemical lithiation. Thus, the transition metal disulfide is preferably a “chemically lithiated” transition metal dichalcogenide.

The lithiated transition metal dichalcogenide is preferably a layered material, as discussed above. The lithium ions are inserted (intercalated) between the layers of the transition metal dichalcogenide. Thus, the material is a transition metal dichalcogenide that is intercalated with lithium.

The working electrode of the invention comprises sulfur (S₈) or a lithium (poly) sulfide. Examples of lithium (poly) sulfides include Li₂S, Li₂S₂, Li₂S₄, Li₂S₆, and Li₂S₈.

The quantity of sulfur in the working electrode may be specified using the mass ratio of (lithiated) transition metal dichalcogenide to sulfur. Typically, the total mass of sulfur, including the sulfur component of lithium polysulfides, is used to calculate the sulfur mass ratio.

Preferably, the mass ratio of LiₐMX₂ to sulfur is from 1:2 to 1:3. More preferably, the mass ratio of LiₐMX2 to sulfur is about 1:2.5.

The quantity of sulfur in the working electrode may alternatively be specified using the percentage weight of sulfur against the total weight of sulfur and active material (lithiated transition metal dichalcogenide) in the working electrode. This may be known as the sulfur fraction. Typically, the sulfur fraction is from 20 wt % to 90 wt %. Preferably, the sulfur fraction is from 40 wt % to 85 wt %, more preferably 50 wt % to 80 wt %, even more preferably 60 wt % to 75 wt %, and most preferably from 70 to 75 wt %.

The quantity of sulfur in the working electrode may also be specified using the areal sulfur loading. That is, the mass of sulfur per unit area of the working electrode. Typically, the areal sulfur loading is 1 mg cm⁻² to 10 mg cm⁻². Preferably, the areal sulfur loading is from 2 mg cm⁻² to 9 mg cm⁻², more preferably 3 mg cm⁻² to 8 mg cm⁻², even more preferably 6 mg cm⁻² to 8 mg cm⁻², and most preferably 7 mg cm⁻² to 8 mg cm⁻².

The form of the sulfur components, whether elemental sulfur or lithium (poly) sulfide, will change during charging and discharging of the electrochemical cell. In the charged state (prior to discharging) the sulfur component is in the form of element sulfur (S₆). During discharging, the sulfur components will change to lithium (poly) sulfides.

The sulfur components, whether elemental sulfur or lithium (poly) sulfide, are typically located between the restacked nanosheets of transition metal dichalcogenide.

Typically, the Li—S cell is manufactured in the charged state. Thus, the working electrode comprises elemental sulfur (S₈). Typically, the working electrode comprises a composite of the metallic phase transition metal dichalcogenide and elemental sulfur.

The metallic phase transition metal dichalcogenide is typically an electrical conductor. Accordingly, the working electrode does not need to contain additional conductive components, such as conductive carbon components. Typical conductive carbon components include carbon black, graphite, nanoparticulate carbon powder, carbon fibre, carbon nanotubes. Specific examples include Ketjen black or Super P carbon. Additional examples include reduced graphene oxide.

Known working electrodes for Li—S cells (such as those using a semiconducting phase transition metal dichalcogenide), include a significant amount of conductive additives (such as conductive carbon). These known electrodes may include conductive carbon at an amount of 10% or more, 20% or more, 30% or more, such as from 30 to 40%. Electrodes using TMD in a semiconducting phase will not have sufficient conductivity when the amount of conductive additive is 10% or less, 5% or less, or 1% or less.

The working electrode may comprise conductive carbon in an amount of 10 wt % or less, such as 5 wt % or less.

Typically, the working electrode comprises conductive carbon in an amount of 3 wt % or less. Preferably, the working electrode comprises conductive carbon in an amount of 2 wt % or less, more preferably 1 wt % or less, and even more preferably 0.5 wt % or less. Most preferably, the working electrode is substantially free from conductive carbon.

The lithiated transition metal dichalcogenide is typically a free-standing material, such as a free-standing film. That is, the lithiated transition metal dichalcogenide does not need to rely on, or be bound to, a support material. Accordingly, the working electrode does not need to contain additional binder components. Typical binder components include PVDF, PTFE, CMC, PAA, PMMA, PEO, SBR and co-polymers thereof.

Typically, the working electrode comprises binder in an amount of 3 wt % or less. preferably, the working electrode comprises binder in an amount of 2 wt % or less, more preferably 1 wt % or less, and even more preferably 0.5 wt % or less. Most preferably, the working electrode is substantially free from binder.

The working electrode in the Li—S cell of the invention comprises the metallic phase transition metal dichalcogenide of formula (I). The working electrode may consist essentially of the metallic phase transition metal dichalcogenide of formula (I).

The working electrode may comprise a current collecting substrate. Any suitable current collecting substrate may be used. Examples of suitable current collecting substrates include an aluminium plate or foil. The lithiated transition metal dichalcogenide of formula (I) may be disposed on the surface of the current collecting substrate.

In a particularly preferred embodiment, there is provided a lithium sulfur cell comprising a working electrode, a counter electrode, and an electrolyte, wherein the working electrode comprises a film comprising:

stacked layers of a metallic phase niobium disulfide of formula (IA); and sulfur or a lithium (poly) sulfide,

NbS₂ (IA).

In some such embodiments, the NbS₂ is in a metallic 3R phase.

In another particularly preferred embodiment, there is provided a lithium sulfur cell comprising a working electrode, a counter electrode, and an electrolyte, wherein the working electrode comprises a film comprising:
stacked layers of a lithiated, metallic phase molybdenum disulfide of formula (IB); and sulfur or a lithium (poly) sulfide,

LiₐMoS₂ (IB)
where:
a is from 0.5 to 0.9, such as 0.6 to 0.8.

The metallic phase transition metal dichalcogenide may be prepared by any suitable method. In some embodiments the metallic phase transition metal dichalcogenide is prepared by the preparation method described herein. In some embodiments the metallic phase transition metal dichalcogenide is prepared by known methods, such as a chemical vapour transport method, an electrochemical treatment method, an e-beam irradiation method, or by pressure application method (Chhowalla et al., 2015).

### Lithium Sulfur Cell

The Li—S cell of the invention comprises a counter electrode and an electrolyte. The Li—S cell may also include a separator. The Li—S cell typically comprises terminals for connection to an external device or an external power supply.

Typically, the counter electrode is the negative electrode. A negative electrode comprising any suitable anode active material may be used. Examples of suitable anode active materials include lithium metal or lithium alloys. The lithium alloys may include alloys of lithium with Mg, Zn, Sn, Sb, Si or Al, such as Li—Sn₂O₃ and Li—SnO₂. Preferably, the counter electrode comprises lithium metal.

The counter electrode may comprise a current collecting substrate. Any suitable current collecting substrate may be used. Examples of suitable current collecting substrates include a copper plate or foil. The anode active material may be disposed on the surface of the current collecting substrate.

The counter electrode may comprise a binder to improve adhesion of the active material to a current collecting surface. Examples of typically binders are PVDF, PTFE, CMC, PAA, PMMA, PEO, SBR and co-polymers thereof.

Typically, the electrolyte in the electrochemical cell is suitable for solubilising lithium ions. Typically, the electrolyte in a charged and discharged cell contains lithium ions.

Typically, the electrolyte comprises a lithium salt, such as LiTFSI, (bis (trifluoromethane) sulfonimide lithium salt, LiPF₆, LiBF₄, LiClO₄, LiNO₃, LiTF (lithium triflate) and lithium bis (oxalato) borate (LiBOB). Preferably, the electrolyte comprises a lithium salt tht has good solubility in ether solvents, such as LiTFSI, LiClO₄, LiTF and LiBOB.

The electrolyte may be a liquid electrolyte, such as a liquid at ambient temperature, for example at 25° C.

Preferably, the electrolyte is a non-aqueous electrolyte. The electrolyte may comprise a polar aprotic solvent. The electrolyte may comprise an organic solvent. Solvents for dissolving lithium ions are well known in the art.

Preferably, the solvent is a solvent having a poor solubility for sulfur and lithium polysulfide.

Preferably, the solvent is an ether solvent. Lithium polysulfide is poorly soluble in ether solvents. Suitable ether solvents include acyclic ethers, cyclic ethers and polyethers.

Examples of suitable acyclic ethers include diethyl ether, dipropyl ether, dibutyl ether, dimethoxymethane, trimethoxymethane, dimethoxyethane, diethoxyethane, 1,2-dimethoxypropane, and 1,3-dimethoxypropane.

Examples of suitable cyclic ethers include tetrahydrofuran, tetrahydropyran, 2-methyltetrahydrofuran, 1,4-dioxane, 1,3-dioxolane, and trioxane.

Examples of suitable polyethers include, diethylene glycol dimethyl ether (diglyme), triethylene glycol dimethyl ether (triglyme), tetraethylene glycol dimethyl ether (tetraglyme), higher glymes, ethylene glycol divinylether, diethylene glycol divinylether, triethylene glycol divinylether, dipropylene glycol dimethyl ether, and butylene glycol ethers.

The electrochemical cell may also include a solid porous membrane positioned between the negative and positive electrodes. The solid-porous membrane may be known as a separator. The solid porous membrane may partially or completely replace the liquid electrolyte. The solid porous membrane may comprise a polymer (e.g., polyethylene, polypropylene, or copolymer thereof) or an inorganic material, such as a transition metal oxide (e.g., titania, zirconia, yttria, hafnia, or niobia) or main group metal oxide, such as silicon oxide, which can be in the form of glass fibre.

Preferably, the solid porous membrane comprises polypropylene.

The solid non-porous membrane may comprise a lithium-ion conductor. For example, LLZO (garnet family), LSPO (LISICON family), LGPS (thio-LISICON family), LATP/LAGP (NASICON family), LLTO (perovskite family) and phosphide/sulfide glass ceramics.

### Method of Manufacture

The invention also provides a method of preparing a lithium sulfur cell. The method may comprise providing a metallic phase transition metal dichalcogenide of formula (I):

LiₐMX₂ (I)
where a, X and M are defined above, and the same preferences apply.

Metallic phase transition metal dichalcogenide from any source may be used. The metallic phase transition metal dichalcogenide may be prepared by lithiating a non-metallic transition metal dichalcogenide. A phase transition to metallic typically accompanies the lithiation. The lithium ions may then be removed (see below) while the material remains in the metallic phase. Chemical or electrochemical lithiation methods may be used.

The transition metal dichalcogenide may be a two-dimensional transition metal dichalcogenide, such as nanosheets, monolayers or flakes of transition metal dichalcogenide.

The 2D transition metal disulfide may be prepared by exfoliation.

Typically, the method comprises exfoliating a transition metal dichalcogenide to provide a metallic phase transition metal dichalcogenide. This may be referred to as the exfoliation step, step (a).

The transition metal dichalcogenide typically has formula (II):

M²X²₂ (II)
where X² is selected from S, Se and Te, and M² is a transition metal.

The transition metal M² may be selected from Ti, Zr, Hf, V, Nb, Ta, Mo, W, Tc, Re, Pd and Pt. Preferably, the transition metal M² is selected from V, Nb, Ta, Mo and W. More preferably, the transition metal M² is Mo.

The chalcogen X² is selected from S, Se and Te. Preferably, the chalcogen X² is S.

As noted above, transition metal dichalcogenides are layered materials. In layered materials, the bonding in-plane (i.e. within the layer or sheet) typically comprises strong chemical bonds, whereas the layers themselves are held together by weaker forces, such as van der Waals forces. Thus, exfoliation provides a quick and efficient route to prepare individual nanosheets or monolayers of the material.

Accordingly, the exfoliation step provides flakes, nanosheets or monolayers of the transition metal dichalcogenide. The flakes, nanosheets or monolayers are two-dimensional materials. The flakes, nanosheets or monolayers may also be referred to as “exfoliated” material (i.e., exfoliated transition metal dichalcogenide).

Preferably, the exfoliation step comprises chemically exfoliating the transition metal dichalcogenide, such as exfoliating the transition metal dichalcogenide with lithium ions.

Additionally, the exfoliation step may comprise chemically exfoliating with any suitable metal ion. Suitable metal ions include group 1 metal ions, such as lithium ions, sodium ions or potassium ions. Preferably, the metal ion is a lithium ion.

The chemical exfoliation step provides lithiated transition metal dichalcogenide in the metallic phase. This avoids the need for a later phase transition step. The exfoliation step may provide the transition metal dichalcogenide in the 1T, 2H or 3R polymorph. In a preferred embodiment, the exfoliation step provides the transition metal dichalcogenide is in the metallic 1T phase.

Preferably, the exfoliation step comprises treating the transition metal dichalcogenide with an organolithium compound. Suitable organolithium compounds include alkyl-and aryllithium compounds. Specific examples of suitable organolithium compounds include butyllithium (such as n-butyllithium, sec-butyllithium, iso-butyllithium and tert-butyllithium) and phenyllithium. Preferably, n-butyllithium is used.

Additionally, the exfoliation step may comprise treating the transition metal dichalcogenide with any suitable metal ion source, such as a group 1 metal ion source. Suitable metal ion sources include organometallic compounds, metal borane compounds, Grignard reagents or metal-metal alloys. Suitable organometallic compounds include alkyl-and aryl-metallic compounds. Specific examples of suitable organometallic compounds include butyllithium (such as n-butyllithium, sec-butyllithium, iso-butyllithium and tert-butyllithium) and phenyllithium. Preferably, n-butyllithium is used. Suitable metal borane compounds include NaBH₄ and LiBH₄, preferably LiBH₄. Suitable Grignard reagents include alkyl-or aryl-magnesium chloride compounds and alkyl-or aryl-magnesium bromide compounds. Suitable metal-metal alloys include sodium-potassium alloy.

Typically, the mole ratio of metal ion source to transition metal dichalcogenide in the exfoliation step is from 1:1 to 5:1. Preferably, the mole ratio of metal ion source to transition metal dichalcogenide in the exfoliation step is from 1:1 to 4:1, more preferably from 1:2 to 1:3.Typically, the mole ratio of metal ion source to transition metal dichalcogenide in the exfoliation step is 1:1 or more. Preferably, the mole ratio of metal ion source to transition metal dichalcogenide in the exfoliation step is 1:2 or more, more preferably 1:3 or more.

Typically, the mole ratio of organolithium reagent to transition metal dichalcogenide in the exfoliation step is from 1:1 to 5:1. Preferably, the mole ratio of organolithium reagent to transition metal dichalcogenide in the exfoliation step is from 1:1 to 4:1, more preferably from 1:2 to 1:3. Typically, the mole ratio of organolithium reagent to transition metal dichalcogenide in the exfoliation step is 1:1 or more. Preferably, the mole ratio of organolithium reagent to transition metal dichalcogenide in the exfoliation step is 1:2 or more, more preferably 1:3 or more.

Typically, the concentration of the metal ion source (such as organolithium reagent) is such that it is present in excess compared to the transition metal dichalcogenide. In other words, the transition metal dichalcogenide is saturated with the metal ion source (such as organolithium reagent). Preferably, the concentration of the metal ion source (such as organolithium reagent) is 1 M or more, more preferably 1.5 M or more, even more preferably 2 M or more. In some embodiments, the concentration may be from 1 M to 3 M, preferably 1.5 M to 2.5 M.

Typically, the exfoliation step takes place in a solvent. Typically, an organic solvent is used. Most commonly, a non-polar organic solvent is used. Preferably, a hydrocarbon solvent is used.

The hydrocarbon solvent may be an aliphatic or aromatic hydrocarbon solvent.

Examples of suitable aliphatic hydrocarbon solvents include linear alkanes such as pentane, hexane, heptane and octane; cycloalkanes such as cyclopentane, cyclohexane, cycloheptane and cyclooctane; and petroleum fractions such as kerosene and petroleum ether. Mixtures of these solvents may be used.

Examples of suitable aromatic hydrocarbon solvents include benzene, toluene and xylene.

Preferably, the organic solvent is an aliphatic hydrocarbon solvent, more preferably the organic solvent is hexane.

The exfoliation step may be performed at ambient temperature (approximately 20° C.). Alternatively, the exfoliation step may be performed at elevated temperature (above ambient temperature; above approximately 20° C.). Methods for providing heat during the exfoliation step are known and include, for example, using a reaction vessel having an external heating jacket.

Typically, the exfoliation step comprises heating the transition metal dichalcogenide at reflux. That is, at the boiling point of the solvent.

The exfoliation step may be performed for sufficient time to allow a desired quantity of the lithiated transition metal dichalcogenide to form. Typically, the exfoliation step is performed until substantially all the transition metal dichalcogenide is consumed.

Typically, the exfoliation step comprises treating the transition metal dichalcogenide with an organolithium compound for 12 hours to 72 hours. Preferably, the exfoliation step comprises exfoliating the transition metal dichalcogenide for 24 hours to 72 hours, more preferably 48 hours to 72 hours.

Typically, the exfoliation step comprises treating the transition metal dichalcogenide with an organolithium compound for 6 hours or more, 8 hours or more, 10 hours or more, 12 hours or more. Preferably, the exfoliation step comprises exfoliating the transition metal dichalcogenide for 24 hours or more, more preferably 36 hours or more, even more preferably 48 hours or more.

Preferably, exfoliation is carried out under conditions that provide a metallic phase TMD. For example, exfoliation is carried by treating the TMD with organolithium compound for a sufficient time and/or at a sufficient mole ratio to provide a metallic phase TMD. The presence of a metallic phase TMD may be confirmed by any suitable analysis method, such as X-ray diffraction, Raman spectroscopy or XPS. For example, an XPS for metallic 1T phase LiₓMoS₂ has peaks at approx. 232 eV and 228 eV compared to the semiconducting 2H phase which has peaks at approx. 233 and 229 eV.

The lithiated transition metal dichalcogenide may be collected, for example, by filtration. Methods of filtration are known.

The lithiated transition metal disulfide may be washed to ensure removal of remaining organolithium regents and organic residues. For example, the lithiated transition metal dichalcogenide may be washed with an organic solvent, typically a non-polar solvent. Preferably, the lithiated transition metal dichalcogenide is washed with a hydrocarbon solvent, such as hexane.

As noted above, the lithium ions may be removed from the lithiated, metallic phase transition metal dichalcogenide while retaining the material in the metallic phase. Removal of the lithium ions may be achieved my washing the lithiated transition metal dichalcogenide with an aqueous solvent. Accordingly, the exfoliation step may optionally comprise washing the lithiated transition metal dichalcogenide with water or an aqueous solvent. Washing the lithiated transition metal dichalcogenide with water can reduce the lithiation rate of the material to 0.05 or less, such as 0.

Sonication improves the removal of the lithium ions. Accordingly, the aqueous washing step may comprise sonicating the lithiated transition metal dichalcogenide in water or an aqueous solvent. The sonication step is performed until substantially all the lithium ions are removed from the transition metal dichalcogenide. Typically, the sonication step is performed for from 15 minutes to 4 hours, such as from 30 minutes to 2 hours, such as about 1 hour.

The (non-lithiated) metallic phase transition metal dichalcogenide may be collected, for example, by filtration or by centrifugation.

The method comprises assembling a working electrode comprising a film comprising stacked layers of the metallic phase transition metal dichalcogenide and sulfur or a lithium (poly) sulfide. This may be referred to as the restacking step, step (b).

The restacking step may comprise filtering a suspension comprising flakes, monolayers, or nanosheets of the metallic phase transition metal dichalcogenide.

The restacking step also comprises loading the working electrode with sulfide or a lithium polysulfide salt.

Any suitable method may be used to load the sulfur component onto the metallic phase transition metal dichalcogenide. Preferably, however, high-temperature annealing or molten diffusion processes are avoided. High-temperature annealing or molten diffusion process processes may cause a partial phase transition from the 1T phase to the less-desired 2H phase.

The loading may take place by coprecipitation or by solvent-based loading.

In the coprecipitation method, a suspension of transition metal dichalcogenide and elemental sulfur (S₈), such as powdered sulfur, is prepared and mixed. The suspension may be prepared by suspending the material obtained in the exfoliation step in a suitable solvent. Preferably, the mass ratio of LiₐMX₂ to sulfur in the suspension is from 1:2 to 1:3. More preferably, the mass ratio of LiₐMX₂ to sulfur is about 1:2.5. Typically, the suspension is prepared in an organic solvent. Suitable solvents include carbon disulfide.

Typically, the suspension is mixed to ensure a uniform distribution of sulfur and metallic phase transition metal dichalcogenide throughout the suspension. Suitable dispersion methods include sonication.

The suspension is filtered to prepare a composite of the metallic phase transition metal dichalcogenide and elemental sulfur. The composite may be removed from the filter medium and used in the working electrode. Alternatively, the suspension may be filtered over a porous conductive material. The porous, conductive material may then be used as the current collector in the working electrode.

Alternatively, a solvent-based loading approach may be used. In such cases, a solution of a lithium (poly) sulfide may be applied to the stacked, layered metallic phase transition metal dichalcogenide, such as a film of the metallic phase transition metal dichalcogenide.

Suitable lithium (poly) sulfides include Li₂S₄, Li₂S₆ and Li₂S₈. The lithium (poly) sulfides may be purchased commercially. Alternatively, they may be prepared by reacting lithium sulfide (Li₂S) with sulfur in the appropriate molar quantities.

Suitable solvents include the electrolyte solvents set out above.

Preferably, the loading comprises coprecipitating the metallic phase transition metal dichalcogenide with sulfur.

The method comprises assembling a lithium sulfur cell comprising the working electrode, a counter electrode and an electrolyte.

The assembly step typically takes place in the absence of oxygen (for example, in an atmosphere containing less than 10 ppm oxygen). The assembly step typically takes place in the absence of water (for example, in an atmosphere containing less than 10 ppm water vapor).

Preferably, the assembly step typically takes place under inert atmosphere, such as an atmosphere or nitrogen or argon.

Any suitable lithium sulfur cell geometry may be used. Suitable geometries include coin cells and pouch cells.

The invention also provides a lithium sulfur cell obtained or obtainable by the method of manufacture set out above.

The lithium sulfur cell set out above, and the lithium sulfur cell obtained or obtainable by the method of manufacture set out above, have excellent electrochemical properties.

The lithium sulfur cells of the invention have excellent sulfur utilisation. Sulfur utilisation is calculated relative to the complete usage of sulfur in the working electrode. Such an electrode will produce 1675 mAh of charge per gram of sulfur. That is, 100% utilization corresponds to a gravimetric capacity of 1675 mAh g⁻¹ of the sulfur in the cell.

Typically, the lithium sulfur cells of the invention have a sulfur utilisation rate or 80% or more. Preferably, the lithium sulfur cells of the invention have a sulfur utilisation rate of 82% or more, more preferably 83% or more.

The lithium sulfur cells of the invention have excellent capacity retention. Typically, the lithium sulfur cells of the invention have a capacity retention of 80% or more over 200 cycles. Preferably, the lithium sulfur cells of the invention have a capacity retention of 82% or more, more preferably 83% or more over 200 cycles.

The lithium sulfur cells of the invention have excellent gravimetric energy density. Typically, the lithium sulfur cells of the invention have a gravimetric energy density of 350 Wh kg⁻¹ or more. Preferably, the lithium sulfur cells of the invention have a gravimetric energy density of 380 Wh kg⁻¹ or more, more preferably 400 Wh kg⁻¹ or more.

The lithium sulfur cells of the invention have excellent volumetric energy density. Typically, the lithium sulfur cells of the invention have a volumetric energy density of 600 Wh L⁻¹ or more. Preferably, the lithium sulfur cells of the invention have a volumetric energy density of 650 Wh L⁻¹ or more, more preferably 700 Wh L⁻¹ or more.

### Method of Charging/Discharging

The invention also provides a method of charging and/or discharging a lithium sulfur cell of the invention.

The method may comprise charging and/or discharging a lithium sulfur cell in the voltage range of 2.8 V to 1.7 V.

The method may involve a cycle of charging and discharging or discharging and charging the electrochemical cell. The cycle may be repeated more than once. Thus, the method of charging/discharging comprises 2 cycles or more, 5 cycles or more, 10 cycles or more, 20 cycles or more or 50 cycles or more.

The electrochemical cell of the invention shows increased capacity retention over prolonged cycling. In the worked examples, a pouch cell is demonstrated to have a capacity retention of 85.2% after 200 cycles, corresponding to a capacity decay of 0.074% per cycle. Accordingly, the method of charging/discharging preferably comprises 100 cycles or more, more preferably 150 cycles or more, even more preferably 200 cycles or more and most preferably 250 cycles or more.

### Battery

The invention also provides a battery comprising one or more lithium sulfur cells of the invention.

Where there is a plurality of cells, these cells may be provided in series or parallel.

A battery of the invention may be provided in a road vehicle, such as an automobile, moped or truck. Alternatively, a battery of the invention may be provided in a rail vehicle, such as a train or a tram. A battery of the invention may also be provided in an electric bicycle (e-bike), a drone, an electric aircraft, and an electric or hybrid boat. Similarly, batteries of the invention may be provided in power tools such as powered drills or saws, garden tools such as lawnmowers or grass trimmers, or home appliances such as toothbrushes or hair dryers.

A battery of the invention may be provided in a regenerative braking system.

A battery of the invention may be provided in a portable electronic device, such as a mobile phone, laptop or tablet.

A battery of the invention may be provided in a power grid management system.

### Uses

The invention also provides the use of a metallic phase transition metal dichalcogenide of formula (I) as a conductive substrate in a working electrode of a lithium sulfur cell:

LiₐMX₂ (I)
where:
   a is from 0.1 to 1.0;
   X is selected from S, Se and Te; and
   M is a transition metal.

In particular, the invention provides the use of a metallic phase transition metal dichalcogenide of formula (I) as a conductive substrate in a working electrode of a lithium sulfur cell.

Using the metallic phase transition metal dichalcogenide of formula (I) as a conductive substrate in a working electrode of a lithium sulfur cell avoids the need to use additional conductive components, such as conductive carbon. This improves the gravimetric and volumetric energy density of the Li—S cell of the invention. In addition, the use of a single material means there are fewer solid-solid interfaces within the electrode, facilitating electron transport to electrocatalytic active sites and allowing the SRR to proceed efficiently.

Preferences for a, X and M, and for the form and structure of the lithiated transition metal dichalcogenide are set out above.

### Definitions

The voltage values described herein are made with reference to Li⁺/Li, as is common in the art.

Gravimetric capacities are quoted based on the mass of the active sulfur in the electrode.

The sulfur utilisation rates are quoted based on the ratio of actual gravimetric capacity to theoretical gravimetric capacity of sulfur. For this purpose, the theoretical gravimetric capacity of sulfur is 1675 mAh g⁻¹.

Volumetric capacities are calculated based on the mass of the gravimetric capacity multiplied by the sulfur packing density in the working electrode.

Gravimetric energy densities are quoted based on the energy per unit mass of the lithium sulfur cell.

Volumetric energy densities are quoted based on the energy per unit volume of the lithium sulfur cell.

The capacity retention is quoted as the ratio of the capacity of the original cell to the capacity of the cell after a specified number of charge-discharge cycles.

### Other Preferences

Each and every compatible combination of the embodiments described above is explicitly disclosed herein, as if each and every combination was individually and explicitly recited.

Various further aspects and embodiments of the invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein. Unless context dictates otherwise, the descriptions and definitions of the features set out above are not limited to any particular aspect or embodiment of the invention and apply equally to all aspects and embodiments which are described.

### EXAMPLES

Certain aspects and embodiments of the invention will now be illustrated by way of example and with reference to the figures described above.

### Preparation of Transition Metal Compounds

1.1—Preparation of LiₓMoS₂

LiₓMoS₂ was prepared by intercalating bulk MoS₂ powder (2H MoS₂) with organolithium reagents. Bulk MoS₂ powder (0.3 g; Alfa Aesar) was immersed in hexane (15 ml; Sigma-Aldrich) under argon, n-butyllithium solution (2.5 M in hexane, 2 mL; Sigma-Aldrich) was next added to the mixture and then refluxed for 2 days. After cooling, the product was washed with hexane (3×50 mL) to remove the remaining organolithium regents and organic residues. The resultant LiₓMoS₂ powder was then dried and stored under an inert atmosphere to avoid oxidation.

### 1.2—Preparation of 1T MoS₂

1T MoS₂ was prepared by ultrasonicating LiₓMoS₂ powder (Preparation Example 1.1) in deionized water (1 mg mL⁻¹) for 30 minutes and then centrifuging at 10,000 rpm to remove lithium cations.

### 1.3—Preparation of 2H MOS₂/C

2H MOS₂/C was prepared by ball-milling 2H MOS₂ (Alfa Aesar) with Super P carbon (MTI Corporation) in a mass ratio of 9:1.

Additional Preparation of transition metal compounds

### 1.4—Preparation of 3R NbS₂

3R NbS2 was prepared by a chemical vapour transport method. A quartz tube containing high-purity Nb (99.99% purity) and S (99.99% purity) in a molar ratio of Nb:S of 1:2 was evacuated at 10⁻⁶ Torr and sealed. The sealed quartz tube was then inserted into a tube furnace. The tube furnace was heated up to 900° C. with a ramp rate of 3° C. min⁻¹. The reaction time was 18 hours at 900° C., and the furnace was then cooled down naturally. The metallic 3R NbS₂ crystals were collected from the quartz tube.

### Preparation of Sulfur Composites

2.1-Preparation LiₓMoS₂/S

The sulfur composite of LiₓMoS₂ (LiₓMoS₂/S) was prepared by a coprecipitation method. LiₓMoS₂ powder (20 mg) and sublimed sulfur powder (50 mg; Alfa Aesar) we dispersed in carbon disulfide solution (5.0 M in hexane, 20 ml; Sigma-Aldrich) with the aid of sonication. The dispersion was then filtered over an anodic aluminium oxide membrane (0.02 μm pore size; Whatman), followed by drying at room temperature under vacuum, to coprecipitate LiₓMOS₂/S.

The areal sulfur loading, which is in direct proportion to the thickness of the films, was adjusted by changing the amount of dispersion at the same concentration.

The volumetric sulfur loading was calculated on the basis of the areal sulfur loading and the corresponding thickness of films.

The mass ratio between LiₓMoS₂ and sublimed sulfur is 1:2.5 (sulfur fraction=71.4 wt. %) for the final preparation.

### 2.2—Preparation of 1T MoS₂/S

The sulfur composite of 1T MoS₂ (1T MoS_{2/}S) were prepared by a coprecipitation method. 1T MoS₂/S was prepared with a similar procedure as described in preparation Example 2.1, but using an ethanol solvent for dispersion.

### 2.3—Preparation of 2H MOS₂/S

The sulfur composite of 2H MOS₂ (2H MOS₂/S) was prepared by a molten diffusion method. 2H MOS₂/S was prepared by ball milling 2H MOS₂ (100 mg) with sublimed sulfur (250 mg) to obtain a fine powder. The mixture was then sealed into a Teflon-lined autoclave under argon and maintained at 155° C. for 12 h. 2H MOS₂/S was collected after a natural cooling process to room temperature.

### 2.4—Preparation of 2H MOS2/C/S

The sulfur composite of 2H MOS₂/C (2H MOS₂/C/S) was prepared by a molten diffusion method. 2H MOS₂/C/S was prepared by ball milling 2H MOS₂/C (100 mg) with sublimed sulfur (250 mg) to obtain a fine powder. The mixture was then sealed into a Teflon-lined autoclave under argon and maintained at 155° C. for 12 h. 2H MOS₂/C/S was collected after a natural cooling process to room temperature.

### Additional Preparation of Sulfur Composites

### 2.5—Preparation of 3R NbS₂/S

The sulfur composite of 3R NbS₂ (3R NbS₂/S) was prepared by a molten diffusion method. 3R NbS₂/S was prepared by ball milling 3R NbS₂ (100 mg) with sublimed sulfur (250 mg) to obtain a fine powder. The mixture was then sealed into a Teflon-lined autoclave under argon and maintained at 155°° C. for 12 h. 3R NbS₂/S was collected after a natural cooling process to room temperature.

Preparation of Electrolyte, LiPS Solution and Li₂S₄ Solution

The electrolyte was prepared by dissolving lithium bis (trifluoromethanesulfonyl) imide (1.0 M; Sigma-Aldrich) and lithium nitrate (0.2 M; Sigma-Aldrich) in 1,3-dioxolane and 1,2-dimethoxyethane (1:1 by volume; Sigma-Aldrich) solvent.

LiPS solution was prepared by reacting lithium sulfide (Li₂S) with sulfur in stoichiometric proportion in the electrolyte.

Li₂S₄ solution (1.0 M) was prepared by adding Li₂S powder (1 mmol; Sigma-Aldrich) and sublimed sulfur (3 mmol) into the electrolyte (1 mL), which was then vigorously stirred at 50°° C. overnight in an argon-filled glovebox.

### Preparation of Coin Cells and Pouch Cells

Coin cells (CR2032) were used to evaluate electrochemical performance of the MoS2-based cathodes. The coin cells were assembled in an argon-filled glovebox with a cathode made of the sulfur composites prepared in Preparation Examples 2.1 to 2.5 (LiₓMoS₂/S, 1T MoS₂/S, 2H MOS₂/S, 2H MOS₂/C/S or 3R NbS₂/S), a lithium foil anode, a Celgard separator and an electrolyte (E/S ratio=12 μl mg⁻¹). These are set out in Table 1—Coin Cells.

(LiₓMOS₂/S, 1T MoS₂/S and 3R NbS₂/S) were used directly as the cathode, whereas 2H MoS₂/S and 2H MOS₂/C/S cathodes were prepared by forming a slurry (90 wt. % 2H MOS₂/S or 2H MOS₂/C/S and 10 wt. % polyvinylidene fluoride binder; (MTI Corporation), then a coating process was carried out to produce their corresponding cathode.

The sulfur loading was set to be 5 mg for all the cathodes used in coin cells unless specifically mentioned otherwise.

TABLE 1
Coin Cells

| Coin cells | Cathode material |
|---|---|
| 3.1 | LiₓMoS₂/S |
| 3.2 | 1T MoS₂/S |
| 3.2 (comparative) | 2H MoS₂/S |
| 3.4 (comparative) | 2H MoS₂/C/S |
| 3.5 | 3R NbS₂/S |

Pouch cells (6 cm×4.5 cm in dimension) were used to evaluate device performance of the LiₓMoS₂-based Li—S batteries. The pouch cells were assembled in a dry room by assembling the cathode made of the sulfur composite prepared in Preparation Example 2.1 (LiₓMoS₂/S) on an Al current collector (MTI Corporation), an anode of lithium foil on Cu current collector (MTI Corporation) and a Celgard separator into Al laminated films (MTI Corporation), followed by the injection of the electrolyte (E/S ratio=2.4 μL mg⁻¹) and finally encapsulation in an argon-filled glovebox. Al and Ni tabs (MTI Corporation) were welded together with the cathodes and anodes, respectively, and introduced for outward connection.

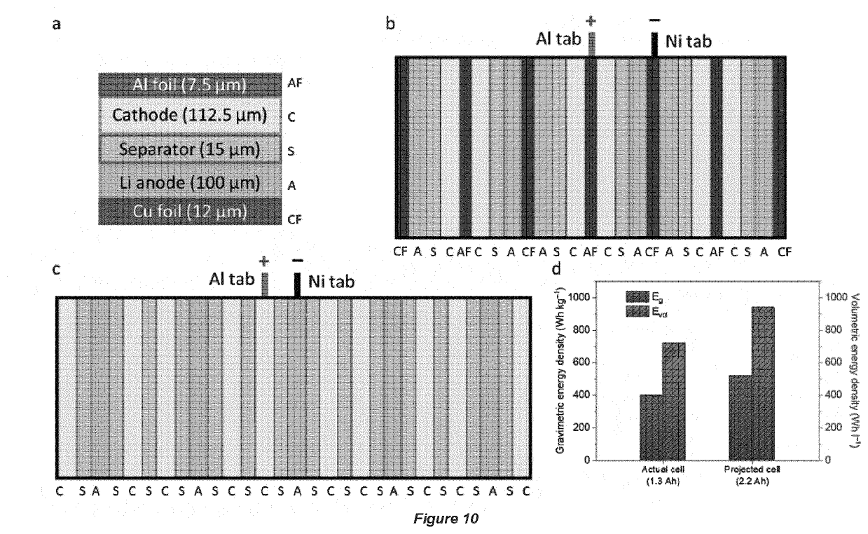

Ah-level pouch cells were assembled in the same way as the pouch cells, with the cathode and the anode alternately stacking layer-by-layer in the cell core. The configuration of the cell core with layer-by-layer stacked Composite 1.1 (LiₓMoS₂) cathodes and the lithium foil anodes (6 layers of each electrode) is shown in FIG. 10b. A pouch cell core for delivering a total capacity of >2 Ah (including 10 layer of each electrode) is shown in FIG. 10c.

Comparative pouch cells are prepared according to the methods described in the following references, set out in Table 2—Comparative pouch cells.

TABLE 2
Comparative pouch cells

| | Cathode material | Reference |
|---|---|---|
| Comparative PC1 | Mo₆S₈ | Xue, W. et al. |
| Comparative PC2 | MWCNT | Chen, J. et al. |
| Comparative PC3 | HKUST-1/CNT | Mao, Y. et al. |
| Comparative PC4 | g-C3N4/graphene | Pang, Q., et al. |
| Comparative PC5 | Double-end binding host | Zhao, C. et al |
| Comparative PC6 | VS4@rGO | Luo et al. |
| Comparative PC7 | Alucone-coated carbon | Li, X. et al. |
| Comparative PC8 | CNT | Wang, W. et al. |
| Comparative PC9 | Integrated carbon black | Shi, L. et al. |
| Comparative PC10 | CNT | Zhang, G. et al. |

### Materials Characterization

The morphological and structural information of materials were characterized by SEM (FEI Magellan 400), XRD (Bruker D8 Advance powder X-ray diffractometer using Cu Kα radiation), Raman spectroscopy (Renishaw InVia using a 514 nm laser beam) and X-ray photoelectron spectroscopy (XPS) (ThermoFisher Scientific using an Al Kα source).

Sulfur contents were determined by thermogravimetric analyses (Setaram Setsys Evolution 18) under an argon atmosphere.

LiPS adsorption was conducted by immersing different materials (10 mg) in the Li₂S₄ solution (10 mM, 5 mL) at room temperature overnight. As a control, identical Li₂S₄ solution was also filled into a blank glass vial. Solutions after the LIPS adsorption test were investigated by UV-vis spectroscopy (Agilent Cary 7000 universal measurement spectrophotometer). The LiPS contact angles were measured by a sessile drop method (droplet: 5 μL of Li₂S₄ solution) using an optical contact angle meter (FTA 1000) in an argon-filled glovebox.

Electrochemical Characterisation The electrocatalytic study was carried out on an electrochemical workstation (ModuLab XM ECS) coupled with a rotating disk electrode (RDE) system (AMETEK Scientific Instruments 636A Rotating Ring-Disk Electrode) in an argon-filled glovebox.

For the preparation of the working electrode, a MoS₂ sample (1 mg) was sonicated in ethanol (480 μL) and 5 wt. % Nafion solution (20 μL; Sigma-Aldrich) for 30 minutes to produce a catalyst ink (2 mg mL⁻¹). The ink (10 μL) was then drop-cast onto the glassy carbon tip of the RDE (0.2 cm²) followed by drying at 60°° C. and transferring into the glovebox.

Electrochemical measurements were conducted in a two-electrode configuration, by using the MoS₂ sample loaded on a RDE (0.1 mg cm²) as the working electrode, and lithium foil (MTI Corporation) as both the counter and reference electrode in the Li₂S₄ solution (8 mM).

Cyclic voltammetry (CV) was scanned at the rate of 10 mV s⁻¹ in the non-Faradaic voltage range of 3.2 V to 3.0 V for 50 cycles to activate the working electrode. The sulfur reduction reaction (SRR) activity was then measured by scanning linear sweep voltammetry (LSV) at the rate of 20 mV s⁻¹ in the voltage range of 2.3 V to 1.5 V with various rotating rates from 0 to 1600 rpm. The electron transfer numbers in the SRR process were calculated on the basis of LSV curves by using the Koutecky-Levich equations: 1/J=1/J_{D}+1/J_{K}=1/Bω^{1/2}+1/J_{K}, where J, J_{D}, and J_{K} are the measured, diffusion-limited, and kinetic-limited current densities respectively; ω is the angular velocity of RDE, and B is the Levich coefficient that can be defined as: B=0.62 nFCD^{2/3} v^{1/6}, where n is the electron transfer number, F is the Faraday constant, C is the concentration of the reactant in electrolyte, D is the diffusion coefficient of the reactant, vis the kinematic viscosity of the electrolyte. This method is also described in Bard, A. J. & Faulkner, L. R. Electrochemical Methods: Fundamentals and Applications (Wiley, 2001).

LSV was also performed in the blank electrolyte without LiPS and used as the background curve to isolate the contribution of the SRR process.

Electrochemical measurements for coin cells were conducted on a battery cycler (Biologic MPG-2).

Galvanostatic charge-discharge (GCD) tests were performed in the voltage range of 2.8 V to 1.7 V at various C rates (1C=1672 mAh g⁻¹). The cycling stability was recorded during continuous GCD cycles at the rate of 1C. Cyclic voltammetry (CV) curves were collected at various scan rates, where the peak currents were used for lithium diffusion coefficient (D_{Li}) calculation by following the Randles-Sevcik equation: i_{P}=(2.69×10⁵)n^{3/2}AD_{Li}^{1/2}C_{Li}v^{1/2}, where i_{P} is the peak current, n is the charge-transfer number, A is the geometric area of the active electrode, D_{Li} is the Li ion diffusion coefficient, C_{Li} is the concentration of lithium ions in the electrode, and vis the scan rate. This method is also described in Bard, A. J. & Faulkner, L. R. Electrochemical Methods: Fundamentals and Applications (Wiley, 2001).

Electrochemical impedance spectroscopy (EIS) was measured at open circuit and specific voltages under a sinusoidal signal over the frequency range from 100 kHz to 10 mHz with an amplitude of 10 mV. An oven and a refrigerator were coupled with the battery cycler to control the temperature during the EIS measurements. The activation energies for various

LiPS conversion steps were calculated according to the Arrhenius equation by using the charge transfer resistance (Rct) that derived from the EIS profiles The reciprocal of the charge transfer resistance fitted from the Nyquist plots (1/Rct) was used to represent the rate constant for calculation of the activation energy at each SRR step, according to Arrhenius equation: k=Ae−Ea/RT, where k is the rate constant, T is the absolute temperature, A is the pre-exponential factor, Eₐ is the activation energy for the reaction, and R is the universal gas constant. This method is also described in Ogihara et al., 2012.

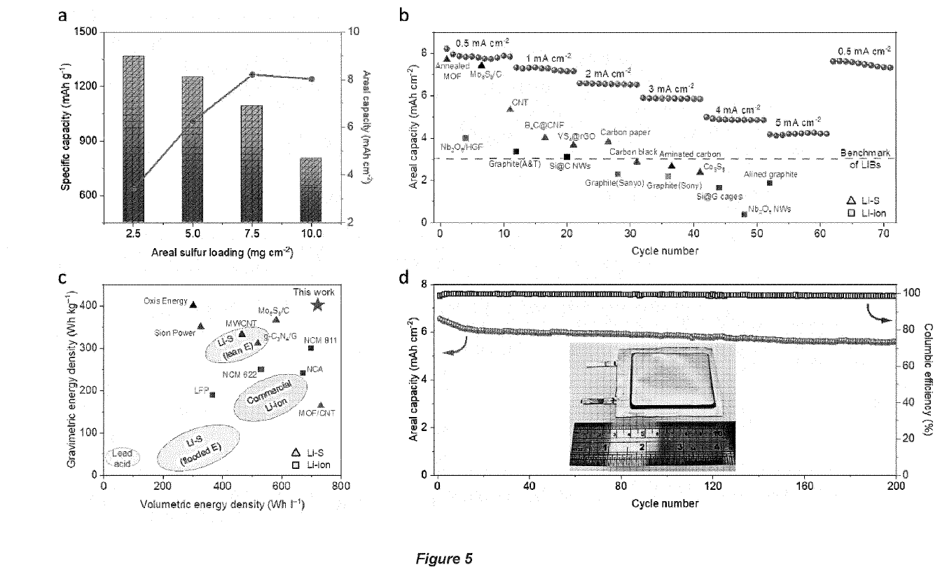

Electrochemical measurements for pouch cells were conducted similarly to that of coin cells, using a 100% depth of discharge. The energy densities of the Ah-level pouch cells were calculated by the following formulas: Eᵥₒₗ=(Cₐᵣₑₐₗ×V)/Σ Tᵢ and E_{g}=(Cₐᵣₑₐₗ×V)/Σ (mₐᵣₑₐ)ᵢ where Eᵥₒₗ and E_{g} are the volumetric and gravimetric energy densities, respectively, Cₐᵣₑₐₗ is the areal capacity, V is the nominal cell voltage (2.1 V), T and mareal are the thickness and areal mass loading of the cell components, including cathodes, anodes, current collectors (ρ_{AI}=2.7 g cm⁻³ and ρ_{Cu}=8.96 g cm⁻³), separators (ρ=0.95 g cm⁻³) and the electrolyte (ρ=1.0 g cm⁻³). The thickness of the electrolyte was not taken into account for the calculation of Eᵥₒₗ. The Cₐᵣₑₐₗ, Eᵥₒₗ and E_{g} values of comparative examples 1 to 10 shown in FIGS. 5b and 5c, and Table 7—Pouch Cell Cₐᵣₑₐₗ and Table 8—Pouch Cell Cycling Lifewere collected either from references as such or calculated using a same method on the basis of reported numbers.

### Results and Discussion

LiₓMoS₂ films were prepared as described in the methods section above.

### Example 1A—Morphologies and Properties of LiₓMoS₂

The mechanical properties of LiₓMoS₂ films were investigated.

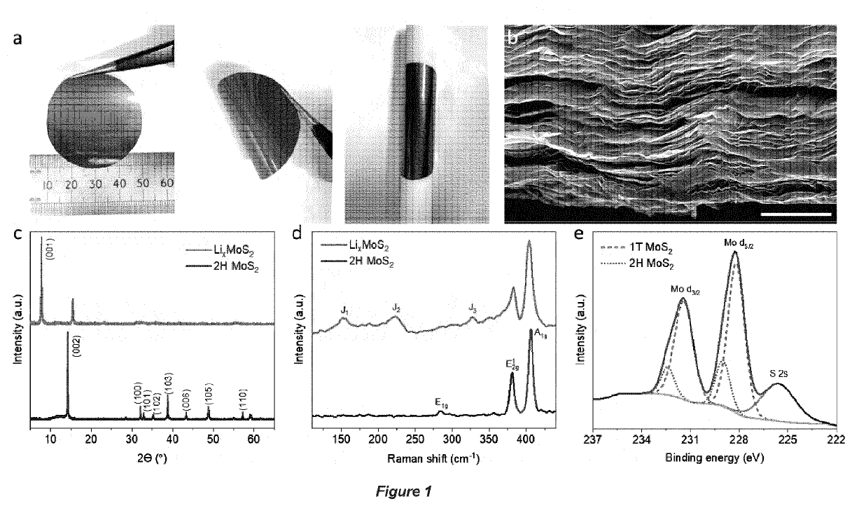

The LiₓMoS₂ films exhibit considerable mechanical flexibility and strength as shown in FIG. 1a.

The cross-section scanning electron microscopy (SEM) image of a typical film (1 mg cm⁻², ˜2.4 μm) as shown in FIG. 1b shows a compact laminar structure with densely stacked nanosheets.

In the X-ray diffraction (XRD) pattern shown in FIG. 1c, a new peak is observed at ˜7.8°,corresponding to the (001) plane resulting from lithiation. There is also a shift of the (002) peak to higher angle in the LiₓMoS₂ compared to 2H MoS₂, suggesting a smaller interlayer distance between the nanosheets. Without wishing to be bound by theory, this is thought to be due to the fact the negatively charged 1T phase MoS₂ nanosheets are attracted to the intercalated Li cations.

The Raman spectrum of the LiₓMoS₂ shown in FIG. 1d shows the usual A_{1g} and E¹_{2g} peaks of MoS₂ as well as additional J₁, J₂ and J₃ peaks that are characteristic of the metallic 1T phase.

The concentration of the 1T phase in lithiated samples was found to be ˜85% using XXPS as shown in FIG. 1e. This is higher than the non-lithiated 1T MoS₂, which contains ˜70% 1T phase.

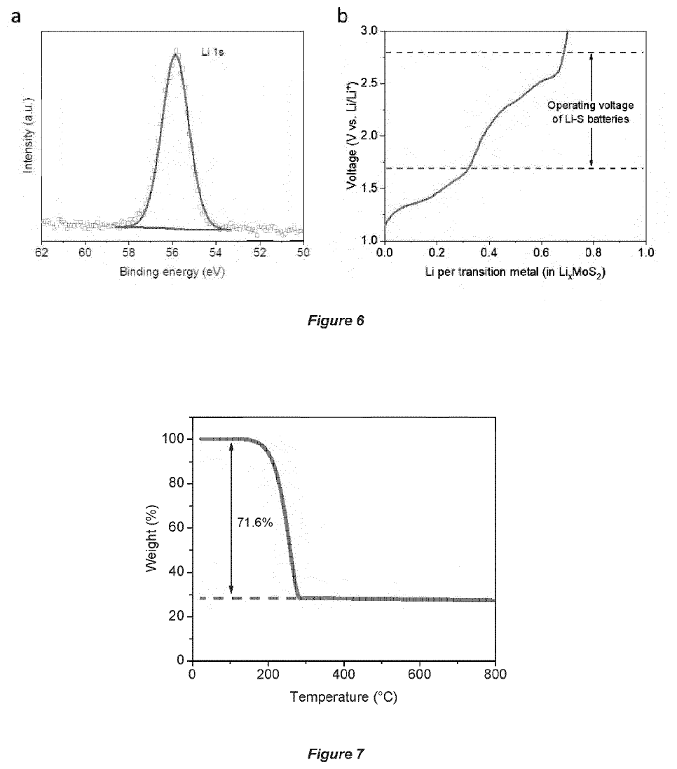

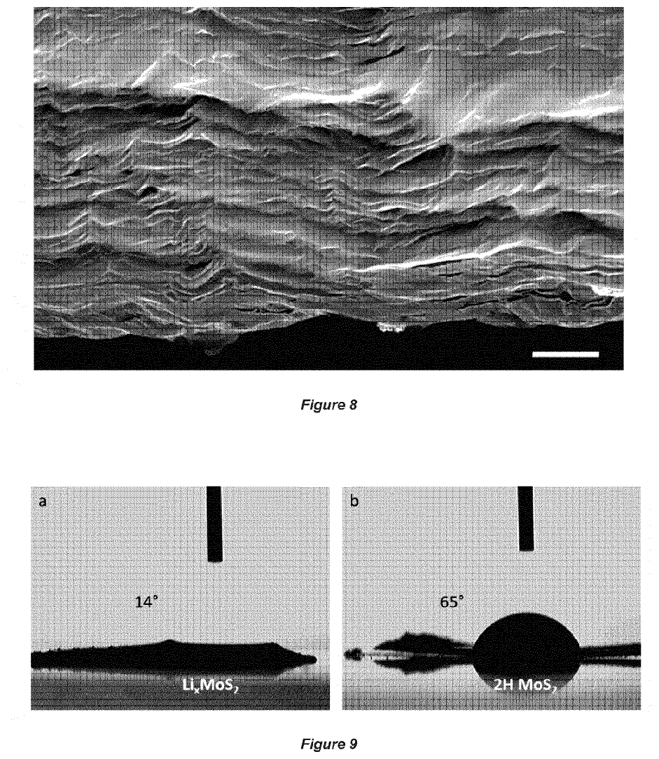

The lithium content in LiₓMoS₂ is founds to be ˜0.7, by an electrochemical lithium extraction measurement in the cell of bare LiₓMoS₂ film versus lithium foil (see FIG. 6b). This content has been further confirmed by a back-titration method, where a known excess amount of diluted HCl was firstly added to LiₓMoS₂, and then the precise excess amount was determined by titration of supernatant with standardized NaOH.

The thermogravimetric analyses of the LiₓMoS₂/S composite show a sulfur content of 71.6 wt. %. This is consistent with the dosage of LiₓMoS₂ and sublimed sulfur in a mass ratio of 1:2.5 (see FIG. 7).

The wetting of an electrolyte on the surface of the cathode is shown in FIG. 9a for LiₓMoS₂/S and FIG. 9b for 2H MOS₂/S. The contact angle for the electrolyte on LiₓMOS₂/S is 14°, compared to 65° for 2H MoS₂/S. There is improved electrolyte wetting of the cathode surface for LiₓMoS₂/S. The more lyophilic property of LiₓMoS₂ than 2H MOS₂ can be attributed to its polar nature, which is beneficial in yielding lower electrode-electrolyte interfacial resistance for Li—S battery cathodes.

### Additional Example 1B—Characterization of 3R-NbS₂

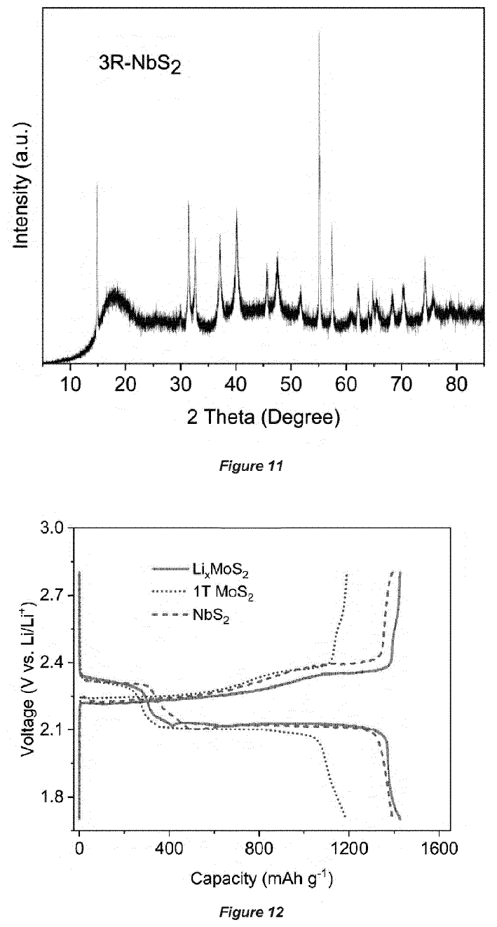

The 3R-NbS₂ prepared in preparation 1.4 was characterized by X-ray diffraction (XRD). The XRD pattern shown in FIG. 11 confirms that the NbS₂ material is in a metallic 3R phase. In particular, the peaks at about 14.8, 30.1, 45.7, 62.5 and 80.6 correspond to literature values for single crystal XRD diffraction of 3R-NbS₂ (see, for example, www.hqgraphene.com/3R-NbS2.php).

The metallic NbS₂ comprises stacked layers of metallic phase NbS₂. The layers or sheets are stacked, and have van der Waals forces acting between the sheets. Without being bound by theory, it is thought these relatively weak interlayer forces facilitate easy intercalation between the layers of metallic phase NbS₂.

### Example 2—Electrochemical Characterization of LiₓMoS₂ Cathodes in Li—S Coin Cells

MoS₂-based and NbS₂-based cathodes were prepared as sulfur composites (LiₓMoS₂/S, MoS₂/S and NbS₂/S) (sulfur >70 wt. %) and assembled into Li—S coin cells with lithium metal anodes as described in the Methods Section. The coin cells used a high E/S ratio of 12 μL mg⁻¹, excess lithium and a relatively low active material amount (areal sulfur loading of 2.5 mg cm⁻² amounting to 5 mg in total).

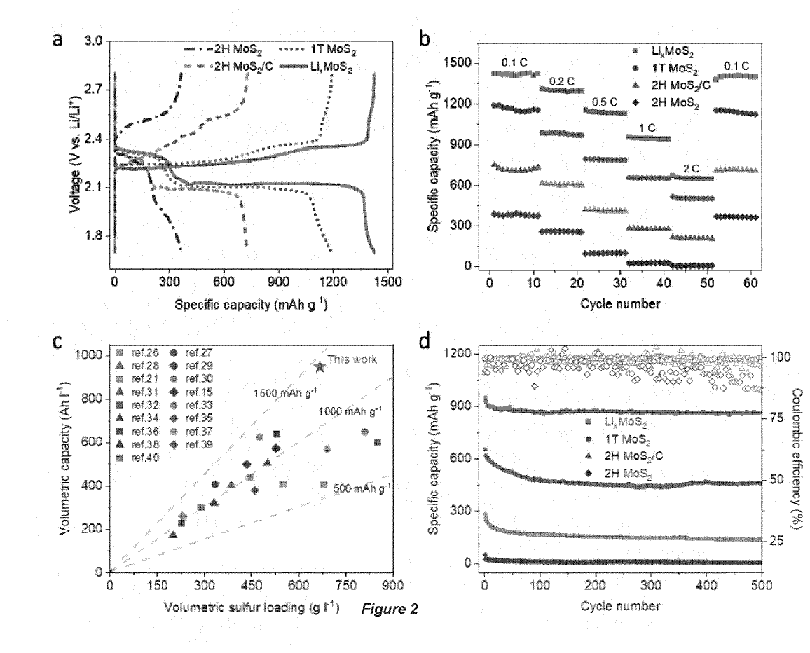

Galvanostatic charge-discharge (GCD) curves of LiₓMoS₂/S. 1T MoS₂/S, 3R—NbS₂/S and other reference 2H-MoS₂/S and 2H MOS₂/C/S cathodes exhibit typical Li—S battery behaviour with two characteristic discharge plateaus at 2.4 V (Li₂S₆ to Li₂S₄) and 2.1 V (Li₂S₄ to Li₂S₂/Li₂S), respectively as shown in FIG. 2a and FIG. 12.

The specific capacity of the coin cells was measured at 0.1 C (see Table 3—Specific capacity of coin cells).

TABLE 3
Specific capacity of coin cells

| Coin Cell | Cathode material | Specific capacity (mAh g⁻¹) |
|---|---|---|
| 3.1 | LiₓMoS₂/S | 1425 |
| 3.2 | 1T MoS₂/S | 1179 |
| 3.2 (comparative) | 2H MoS₂/S | 364 |
| 3.4 (comparative) | 2H MoS₂/C/S | 728 |
| 3.5 | 3R-NbS₂/S | 1390 |

The LiₓMoS₂/S cathode showed a specific capacity of 1425 mAh g⁻¹ at 0.1C. This is much higher than cathodes made from 2H MOS₂ (364 mAh g⁻¹) and 2H MOS₂/C (728 mAh g⁻¹). The 1T MoS₂ cathode showed a specific capacity of 1179 mAh g⁻¹ at 0.1C, which is also significantly higher than cathodes made from 2H MOS₂ and 2H MOS₂/C. The 3R-NbS₂/S cathode showed a specific capacity of 1390 mAh g⁻¹, which is higher than reference 2H MOS₂ cathodes, and also slightly higher than the 1T MoS₂ cathode (see FIG. 12). The LiₓMoS₂/S cathode has a higher specific capacity at 0.1C than the NbS₂ cathode.

Notably, this capacity indicates a sulfur utilization rate for the LiₓMoS₂/S cathode of 85.2% (theoretical capacity for 100% sulfur utilization is 1672 mAh g⁻¹). In addition, among these cathodes, LiₓMoS₂ showed the lowest polarization voltage gap under identical conditions, suggesting earlier anodic/cathodic reaction during charge/discharge process. It is though this is due to improved electrocatalytic activity.

Additionally, the specific capacity for the 3R-NbS₂/S electrode indicates a sulfur utilization rate of about 83%. The NbS₂ cathode also showed a good polarization voltage gap.

The LiₓMoS₂ cathode shows improved rate capability and 67% capacity retention at 1C (as shown in FIG. 2b) which also suggests improved Li ion diffusivity and reaction kinetics.

The volumetric capacity and sulfur loading of the LiₓMoS₂ cathodes was compared to different reference cathodes as shown in FIG. 2c (described in the Electrochemical characterization Section). The volumetric sulfur loading values from reference cathodes shown in FIG. 2c were collected either from references as such or calculated using the same method as described in the examples section. The LiₓMoS₂ cathodes reported here exhibit among the highest values, having a volumetric sulfur loading of 667 g L⁻¹. It is therefore possible for the cathode to deliver a volumetric capacity of 950 Ah L⁻¹.

It is thought the reduced electrolyte dosage and compact sulfur confinement minimize the dissolution of lithium polysulfides (LiPS) that can cause capacity fading via the shuttling effect.

The capacity retention for the LiₓMoS₂/S cathode, 1T MoS₂, and comparative cathodes over 500 cycles at 1C was measured (see FIG. 2d). The capacity retention for the LiₓMoS₂ cathode was 91%. This is higher than the 70% capacity retention for 1T MoS₂, 47% for 2H MoS₂/C and 22% for 2H MOS₂ cathodes.

Without wishing to be bound by theory, it is thought that the improved performance of LiₓMoS₂ is due to improved adsorption of LiPS, enhanced Li ion diffusivity and accelerated electrochemical reaction kinetics. These lead to higher electrocatalytic activity which results in the high capacity and cycling stability of Li—S batteries with LiₓMoS₂ cathodes. Also, it is though that the reduced electrolyte dosage and compact sulfur confinement minimize the dissolution of lithium polysulfides (LiPS) that can cause capacity fading via the shuttling effect.

### Example 3—Lithium Polysulfides (LiPS) Adsorption, Li Ion Diffusivity and Electrochemical Reaction Kinetics of LiₓMos₂ Cathodes

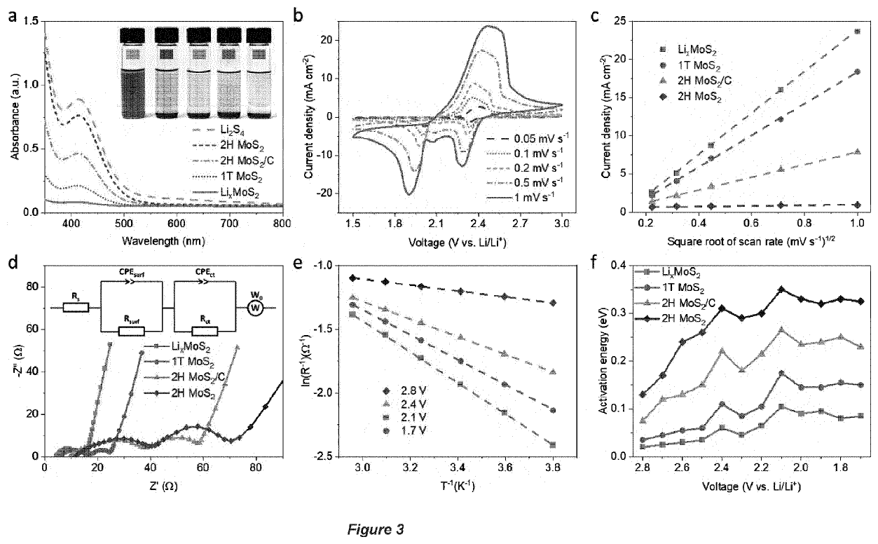

Polysulfide-adsorption measurements on different MoS₂ hosts with Li₂S₄ solution were conducted. It can be seen in the photograph of FIG. 3a that most of the Li₂S₄ is adsorbed onto the LiₓMoS₂ host, resulting in a transparent solution compared with that of other hosts. This higher affinity of the LiₓMoS₂ host for LiPS is quantitatively confirmed by ultraviolet-visible (UVvis) spectroscopy (FIG. 3a).

The efficient adsorption of Li₂S₄ product is important not only in facilitating the conversion process (increasing capacity) but also for minimizing the shuttling effect (increasing cycling stability). This thought to be because during the overall Li—S battery reaction (S₈+16e⁻+16Li⁺⇄8Li₂S), of the 16 electrons transferred, 12 electrons are from the conversion of Li₂S₄ to Li₂S (via 2Li₂S₄+12e⁻+12Li⁺⇄8Li₂S; balanced by same amount of sulfur). So, 75% of the capacity is from the conversion of Li₂S₄ to final Li₂S. This also corresponds to the largest discharge plateau at ˜2.1 V (see FIG. 2a) which normally takes the longest time to proceed. The longer exposure of Li₂S₄ to electrolyte than other Li.S species means that Li₂S₄ has a higher probability for dissolution and shuttling.

The Li ion diffusion coefficient (D_{Li}) was calculated from cyclic voltammetry (CV) results by using the Randles-Sevcik equation (as explained in the Method Section). The CV curves exhibit two cathodic peaks and one anodic peak (FIG. 3b), which corresponds to the two discharge and one charge plateaus observed in GCD curves in FIG. 2a.

Peak currents at various scan rates were used to extract the D_{Li} for different cathodes (FIG. 3c). The DLi in LiₓMoS₂ cathodes was found to be 5.1×10⁻⁸ cm² s⁻¹, which is 71% higher than in 1T MoS₂ cathodes (3.0×10⁻⁸ cm² s⁻¹).

Without wishing to be bound by theory, it is thought this is due to intercalated Li between the metallic MoS₂ nanosheets facilitating the diffusion of Li ions through the material. The D_{Li} in LiₓMoS₂ cathodes is over an order of magnitude higher than in 2H MOS2/C (4.9×10⁻⁹ cm² s⁻¹) as a result of the metallic 1T phase. The difference in Du explains the observed differences in rate capabilities of MoS₂ based cathodes (shown in FIG. 2b).

The Li ion diffusivity of LiₓMoS₂ cathodes was also measured by electrochemical impedance spectroscopy (EIS) profiles, as shown in Nyquist plots in FIG. 3d. The higher slope in the low frequency region suggests enhanced ion diffusion behaviour. FIG. 3d shows the equivalent circuit used for fitting EIS profiles. The resistor elements in the circuit are: Rₛ, combined internal resistance, including the interfacial contact resistance between the material and current collector, the ohmic resistance of electrolyte and the intrinsic resistance of current collector; R_{sulf}, sulfur deposition resistance, attributed to the deposition of insoluble LiPS on electrode surface; R_{ct}, charge transfer resistance, representing the resistance of electrochemical reactions.

The activation energy (Eₐ) required for each polysulfide conversion step was investigated on different cathodes using EIS, to reveal the kinetics of the electrochemical reactions. The measurements were conducted at voltages where important reactions occur and at different temperatures. Nyquist plots at 2.1 V (where the critical step of Li₂S₄ conversion occurs) are shown in FIG. 3d. Fitting the curves with the equivalent circuit shows that the LiₓMoS₂ cathodes possess the lowest internal resistance (Rₛ) and charge transfer resistance (R_{ct}). The

Arrhenius equation was then employed to obtain Eₐ (FIG. 3e), where the reciprocal of the charge transfer resistance (1/R_{ct}) is used to represent the rate of sulfur reduction reaction (SRR) since the reaction proceeds with charge transfer. The Eₐ values at different voltages are summarized in FIG. 3f.

For each cathode, the Eₐ values at 2.4 V and 2.1 V are higher than at their adjacent voltages. The reaction at 2.1 V, which corresponds to the conversion process from Li₂S₄ to Li₂S₂/Li₂S, shows the highest Eₐ among all voltages indicating that it is the rate determining step for the entire Li—S battery reaction. Among the different cathodes, LiₓMoS₂ clearly exhibits the lowest Eₐ at each polysulfide conversion step. For example, at 2.1 V, the Eₐ of LiₓMoS₂ cathodes is ˜34% and ˜70% lower than 1T MoS₂ and 2H MOS₂, respectively.

This shows improved LiPS adsorption along with enhanced Li ion diffusivity and reaction kinetics for LiₓMoS₂ cathodes.

### Example 4—Electrocatalytic Sulfur Reduction Reaction (SRR) Study Of LiₓMoS₂ Cathodes in Li₂S₄ Solution Using Rotating Disk Electrode (RDE) System.

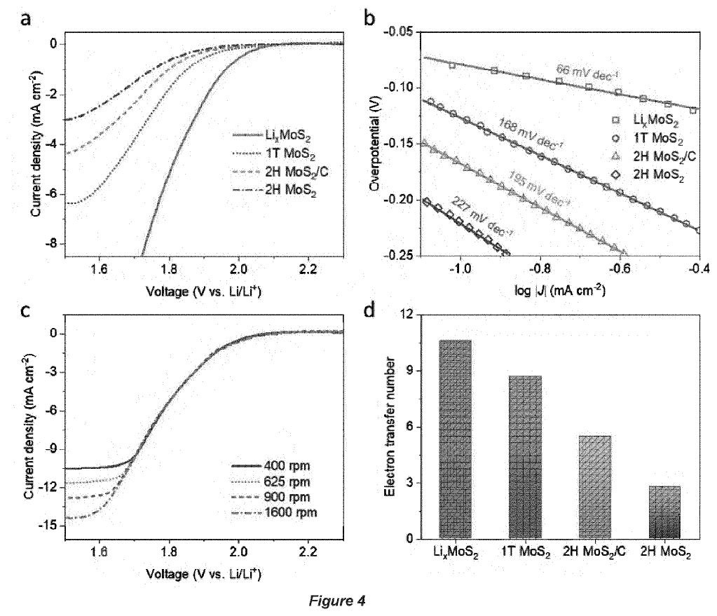

The SRR properties for Li₂S₄ conversion was studied by linear sweep voltammetry (LSV). The onset potentials are shown in Table 4—Onset potential of cathode materials measured by LSV and FIG. 4a.

TABLE 4
Onset potential of cathode materials measured by LSV

| Cathode material | Onset potential (V) |
|---|---|
| LiₓMoS₂/S | 2.12 |
| 1T MoS₂/S | 2.03 |
| 2H MoS₂/S (comparative) | 1.91 |
| 2H MoS₂/C/S (comparative) | 1.95 |

The LSV curves in FIG. 4a show that LiₓMoS₂ possess an onset potential of 2.12 V, which is considerably higher than the onset potential of 1T MoS₂ (2.03 V), 2H MoS₂/C (1.95 V) and 2H MOS₂ (1.91 V). That is, LiₓMoS₂ has the lowest overpotential, which indicates the highest electrocatalytic activity for the SRR. This is also indicated by higher half-wave potential and a larger diffusion-limited current density (JD).

Tafel slopes obtained from LSV profiles were recorded and shown in FIG. 4b. The gradient of the Tafel slope is given in Table 5—Gradient of Tafel slope measured by LSV.

TABLE 5
Gradient of Tafel slope measured by LSV

| Cathode material | Tafel slope (mV dec⁻¹) |
|---|---|
| LiₓMoS₂/S | 66 |
| 1T MoS₂/S | 168 |
| 2H MoS₂/S (comparative) | 227 |
| 2H MoS₂/C/S (comparative) | 195 |

The gradient of the Tafel slope indicates the reaction kinetics and activity of electrocatalysts in the form of potential required to increase the current density by an order of magnitude. LiₓMoS₂ exhibits substantially lower Tafel slopes (66 mV dec⁻¹) than 1T MoS₂ (168 mV dec⁻¹), 2H MoS₂/C (195 mV dec⁻¹) and 2H MoS₂ (227 mV dec⁻¹), indicating higher electrocatalytic activity and accelerated reaction kinetics. This is consistent with its low Ea discussed above.

It can be seen from LSV curves in FIG. 4a that JD values for LiₓMoS₂ are higher than other reference MoS₂ hosts. Considering that an equal mass loading of different materials was used for the measurements, the higher current for LiₓMoS₂ indicates that a larger number of electrons are transferred during the SRR process.

LSV measurements were performed at different rotation rates (shown in FIG. 4c). This demonstrates that the diffusion-limited current density increases with the angular velocity of RDE.

The resultant JD is used to calculate electron transfer numbers according to the Koutecky-Levich equation (as explained in the methods section above). The electron transfer numbers for different MoS₂ hosts are provided in FIG. 4d and in Table 6—Electron transfer numbers for different cathodes.

TABLE 6
Electron transfer numbers for different cathodes

| Cathode material | Electron transfer number |
|---|---|
| LiₓMoS₂/S | 10.6 |
| 1T MoS₂/S | 8.7 |
| 2H MoS₂/S (comparative) | 2.8 |
| 2H MoS₂/C/S (comparative) | 5.5 |

LiₓMoS₂ shows an electron transfer number of ˜10.6, larger than those for 1T MoS₂ (8.7), 2H MoS₂/C (5.5) and 2H MOS₂ (2.8), suggesting higher electrocatalytic activity of LiₓMoS₂ for promoting the conversion of Li₂S₄ to Li₂S. As a total of 12 electrons are transferred for the complete conversion of Li₂S₄ to Li₂S, this electron transfer number of 10.6 is equivalent to a conversion fraction of 88.3%. This is in good agreement with the sulfur utilization rate of 85.1% obtained from coin cells (discussed above).

This indicates that LiₓMoS₂ exhibits superior electrocatalytic activity towards the SRR, enhanced Li ion diffusivity, accelerated reaction kinetics and improved adsorption of LiPS for mitigation of shuttling effects. All of these attributes increase the capacity, rate capability and cycling stability of the LiₓMoS₂ cathode.

### Example 5—Performance of LiₓMoS₂—based Li—S Pouch Cells

Pouch cells were fabricated with LiₓMOS cathodes and lithium metal anodes using a pre-optimized E/S ratio of 2.4 μL mg⁻¹ (as described in the Methods Section). The comparative pouch cells PC1 to PC10 were prepared according to the reference provided in the Methods section.

For energy storage devices (for example, pouch cell level Li—S batteries and LIBs), areal capacity (Cₐᵣₑₐₗ) is a key indicator of performance. The most straightforward way of increasing Cₐᵣₑₐₗ in Li—S battery is to increase the areal sulfur loading. However, increased loading is usually accompanied by sluggish ion diffusion across the thicker electrode, resulting in the degradation of specific capacity and consequently Cₐᵣₑₐ.

For the example pouch cells, it can be seen from FIG. 5a that Cₐᵣₑₐₗ is optimized at a sulfur loading of 7.5 mg cm⁻² (sulfur fraction in cathodes was kept constant at 71.4 wt %), achieving Cₐᵣₑₐₗ of 8.21 mAh cm⁻². Cₐᵣₑₐₗ of over 8 mAh cm⁻² is excellent compared to known Li—S pouch cells, as shown in FIG. 5b and Table 7—Pouch Cell Cₐᵣₑₐₗ and also exceeds the benchmark value of 3 mAh cm⁻² for commercial LIBs. The LiₓMoS₂—based pouch cells exhibit excellent rate capability as shown in FIG. 5b, retaining over 4 mAh cm² even at a high current density of 5 mA cm². This corresponds to a fast-charging process completed within 1 hour.

TABLE 7
Pouch Cell Cₐᵣₑₐₗ

| | | Areal S | Sulfur | Cₐᵣₑₐₗ |
|---|---|---|---|---|
| | | loading | fraction | (mAh |
| | Cathode | (mg cm⁻²) | (wt. %) | cm⁻²) |
| Pouch Cell | LiₓMoS₂ | 7.5 | 71.4 | 8.21 |
| Comparative PC1 | Mo6S8 | 6.9 | 42.8 | 7.54 |
| Comparative PC2 | MWCNT | 4 | 64 | 4.6 |
| Comparative PC3 | HKUST-1/CNT | 11.33 | 68.2 | 6.59 |
| Comparative PC4 | g-C3N4/ | 5.2 | 65.5 | 5.15 |
| | graphene | | | |
| Comparative PC5 | Double-end | 6.25 | 62.5 | 7.86 |
| | binding host | | | |
| Comparative PC6 | VS4@rGO | 5 | 70 | 3.65 |
| Comparative PC7 | Alucone-coated | 2.9 | 58.5 | 3.25 |
| | carbon | | | |
| Comparative PC8 | CNT | 7 | 56 | 4.7 |
| Comparative PC9 | Integrated | 6 | 64 | 5.88 |
| | carbon black | | | |
| Comparative PC10 | CNT | 2.5 | 63 | 3.81 |

Capacities of known Li—S batteries are often low, having total capacities of <1 Ah. This is lower than those required for practical power sources. For example, most commercial batteries operate at 1-2 Ah or higher capacity levels. Therefore, it is more meaningful to compare energy densities of batteries operating at >1 Ah levels.

The example Ah-level Li—S pouch cells (described in the Method Section above) have a total capacity of 1.33 Ah. This capacity is projected to be increased to >2 Ah by employing industrial manufacturing techniques and an optimized configuration. For example, a total capacity of 2.2 Ah can be achieved by stacking 10 layers of the cathode (as shown in FIG. 10c).

Energy density was measured for the Ah-level pouch cells and compared to known LIBs, Li—S batteries and lead-acid batteries are shown in FIG. 5c. The LiₓMoS₂—based pouch cells provide a high gravimetric energy density of 402 Wh kg⁻¹ and volumetric energy density of 721 Wh L⁻¹. These energy densities are excellent for Li—S pouch cells and are excellent compared to commercial Li—S and LIB systems, including Li—S batteries from Oxis Energy and Sion Power, and LIBs of LifePO₄ (LFP, from BYD), LiNi_{0.8}Co_{0.1}Mn_{0.1}O₂ (NCM 811, from CATL), LiNi_{0.6}Co_{0.2}Mn_{0.2}O₂ (NCM 622, from LG), and LiNi_{0.8}CO_{0.15}Al_{0.05}O₂ (NCA, from Panasonic).

Gravimetric and volumetric energy densities have been calculated for the projected >2 Ah Ah-level pouch cells which may be achievable by industrial manufacturing techniques and an optimized configuration (see FIG. 10d). This shows a projected enhancement of ˜30% on gravimetric and volumetric energy densities after optimization (Eg=520 Wh kg⁻¹ and Evol=940 Wh l⁻¹).

Cycling life was measured for the pouch cells. The pouch cells have a capacity retention of 85.2% after 200 cycles, corresponding to a capacity decay of 0.074% per cycle. The cycling stability is excellent compared to known Li—S batteries, as shown in Table 8—Pouch Cell Cycling Life. The cycling stability is also excellent compared to commercial LIBs, which are designed to retain around 80% of their original capacity for 200 complete charge cycles. These results from the LiₓMoS₂-based Li—S pouch cells demonstrate their many advantages as energy storage devices.

TABLE 8
Pouch Cell Cycling Life

| | | Total | Decay |
|---|---|---|---|
| | | number of | per cycle |
| | Cathode | Cycles | (%) |
| Pouch Cell | LiₐMoS₂ | 200 | 0.074 |
| Comparative PC1 | Mo₆S₈ | 10 | 1.8 |
| Comparative PC2 | MWCNT | 100 | 0.127 |
| Comparative PC3 | HKUST-1/CNT | 200 | 0.08 |
| Comparative PC4 | g-C₃N₄/graphene | 80 | 0.461 |
| Comparative PC5 | Double-end binding host | 80 | 0.325 |
| Comparative PC6 | VS4@rGO | 50 | 0.38 |
| Comparative PC7 | Alucone-coated carbon | 5 | 11.3 |
| Comparative PC8 | CNT | 120 | 0.433 |
| Comparative PC9 | Integrated carbon black | 22 | 3.18 |

### REFERENCES

A number of publications are cited above in order to more fully describe and disclose the invention and the state of the art to which the invention pertains. Full citations for these references are provided below. The entirety of each of these references is incorporated herein.
Bediako et al. Nature, 2018, Vol. 558, pp. 425-429.
Chen et al., Nano Lett., 2017, Vol. 17, pp. 3061-3067.
Chhowalla et al., Nature Chemistry, 2013, Vol. 5, pp. 263-275.
Chhowalla et al., Chem. Soc. Rev., 2015, Vol. 44, 2702-2712.
Li et al., Nat. Commun., 2018, Vol. 9, No. 4509.
Luo et al., “ACS Energy Lett., 2020, Vol. 5, pp. 1177-1185.
Mao et al., Nat. Commun. 2017, Vol. 8, No. 14628.
Ogihara et al., J. Electrochem. Soc., 2012, Vol. 159, pp. A1034-A1039.
Pang et al., Adv. Energy Mater. 2017, Vol. 7, No. 1601630.
Shi et al., Energy Environ. Sci., 2020, Vol. 13, pp. 3620-3632.
Wang et al., Energy Storage Mater., 2019, Vol. 18, pp. 414-422.
Xue et al., Nat. Energy, 2019, Vol. 4, pp. 374-382.
Zhao et al., “Nat. Nanotechnol., 2021, Vol. 16, pp. 166-173.
Zhang et al., Angew. Chemie—Int. Ed., 2018, Vol. 57, pp. 16732-16736.
CN 108232164
CN 108649194
CN 111293293
KR 1020200025409
US 2019/0165365
WO 2018/226158

1. A lithium sulfur cell comprising a working electrode, a counter electrode, and an electrolyte, wherein the working electrode comprises a film comprising:
stacked layers of a metallic phase transition metal dichalcogenide (TMD) of formula (I); and
sulfur or a lithium (poly) sulfide,
LiₐMX₂ (I)
where:
a is from 0 to 2.0;
X is selected from S, Se and Te; and
M is a transition metal.

2. The lithium sulfur cell of claim 1, wherein the TMD is a two-dimensional TMD, optionally wherein the working electrode comprises stacked nanolayers or monolayers of the TMD.

3. The lithium sulfur cell of claim 1 or 2, wherein the TMD is an exfoliated TMD.

4. The lithium sulfur cell of any of claims 1 to 3, wherein the TMD is a pre-lithiated TMD, such as where a is from 0.1 to 2.0, preferably 0.5 to 1.0, more preferably from 0.6 to 0.8.

5. The lithium sulfur cell of any of claims 1 to 3 wherein a is 0.

6. The lithium sulfur cell of any of claims 1 to 5, wherein X is S.

7. The lithium sulfur cell of any of claims 1 to 6, wherein M is selected from V, Nb, Mo and W; preferably wherein M is Mo or Nb.

8. The lithium sulfur cell of any of claims 1 to 7, wherein the mass ratio of LiₐMX₂ to sulfur is from 1:2 to 1:3.

9. The lithium sulfur cell of any of claims 1 to 8, wherein the working electrode comprises:
(a) conductive carbon in an amount of 1 wt % or less; and/or
(b) binder in an amount of 1 wt % or less.

10. A method of preparing a lithium sulfur cell, the method comprising:
(a) exfoliating a transition metal dichalcogenide (TMD) to provide a metallic phase, TMD of formula (I):
LiₐMX₂ (I)
where:
a is from 0 to 2.0;
X is selected from S, Se and Te; and
M is a transition metal,
(b) assembling a working electrode comprising a film comprising stacked layers of the metallic phase TMD and sulfur or a lithium (poly) sulfide; and
(c) assembling a lithium sulfur cell comprising the working electrode, a counter electrode and an electrolyte.

11. The method of claim 10, wherein step (a) comprises chemically exfoliating the TMD, such as treating the TMD with an organolithium compound, preferably a butyllithium compound.

12. The method of claim 10 or 11, wherein step (b) comprises forming a composite of the transition metal dichalcogenide and sulfur.

13. The method of any of claims 10 to 12, wherein step (b) comprises coprecipitating the transition metal dichalcogenide with sulfur, such as powdered sulfur.

14. The method of any one of claims 10 to 13, wherein in step (b), the mass ratio of LiₐMX₂ to sulfur is from 1:2 to 1:3.

15. The method of any one of claims 10 to 14, wherein a is from 0.5 to 1.0, preferably from 0.6 to 0.8.

16. The method of any one of claims 10 to 15, wherein:
i) X is S; and/or
ii) M is selected from V, Nb, Mo and W; preferably wherein M is Mo.

17. A lithium sulfur cell obtained or obtainable by the method of any one of claims 10 to 16.

18. The lithium sulfur cell of any one of claims 1 to 9 and 17, wherein the cell has a sulfur utilization rate of 80% or more.

19. The lithium sulfur cell of any one of claims 1 to 9 and 17 to 18, wherein the cell has a capacity retention of 80% or more over 200 cycles.

20. The lithium sulfur cell of any one of claims 1 to 9 and 17 to 19, wherein the working electrode has an areal sulfur loading of from 6 to 10 mg cm⁻².

21. The lithium sulfur cell of any one of claims 1 to 9 and 17 to 20, wherein the cell has a gravimetric energy density of 350 Wh kg⁻¹ or more.

22. The lithium sulfur cell of any one of claims 1 to 9 and 17 to 21, wherein the cell has a volumetric energy density of 650 Wh L⁻¹ or more.

23. A lithium sulfur battery comprising one or more lithium sulfur cells of any one of claims 1 to 9 and 17 to 22.

24. A method of charging and/or discharging the lithium sulfur cell of any one of claims 1 to 9 and 17 to 22, or the lithium sulfur battery of claim 23.

25. Use of a metallic phase, transition metal dichalcogenide of formula (I) as a conductive substrate in a working electrode of a lithium sulfur cell,
LiₐMX₂ (I)
where:
a is from 0 to 2.0;
X is selected from S, Se and Te; and
M is a transition metal.
